(19) United States
(12) Patent Application Publication
(10) Pub. No.: US 2019/0072208 A1
(43) Pub. Date: Mar. 7, 2019

(54) WATER SOFTENER VALVE AND WATER SOFTENER

(71) Applicants: FOSHAN MIDEA CHUNGHO WATER PURIFICATION EQUIPMENT CO., LTD., Foshan (CN); FOSHAN SHUNDE MIDEA WATER DISPENSER MANUFACTURING CO., LTD., Foshan (CN); MIDEA GROUP CO., LATD., Foshan (CN)

(72) Inventors: Guohua LIU, Foshan (CN); Zhifeng HE, Foshan (CN)

(21) Appl. No.: 16/179,945

(22) Filed: Nov. 4, 2018

(30) Foreign Application Priority Data
Apr. 28, 2018 (CN) 201810408342.5
Apr. 28, 2018 (CN) 201810409439.8
Apr. 28, 2018 (CN) 201820639367.1
Apr. 28, 2018 (CN) 201820641563.2
Apr. 28, 2018 (CN) 201820641932.8
Apr. 28, 2018 (CN) 201820646191.2
Apr. 28, 2018 (CN) 201820948457.9

(51) Int. Cl. F16K 31/524; F16K 31/53; F16K 31/16; C02F 1/42; F16K 27/04; C02F 1/52; F16K 11/18

(52) U.S. Cl. CPC F16K 31/52475; F16K 31/53; F16K 31/16; C02F 1/42; C02F 2209/40; C02F 1/5245; F16K 11/18; C02F 2303/16; F16K 27/041

(57) ABSTRACT

Disclosed are a water softener valve and a water softener. The water softener valve includes a valve body, a spacer group, and a piston assembly, the piston assembly including a piston body and a piston rod. The piston assembly defines a water passage through two ends of the piston assembly, the outer peripheral surface of the piston body is alternately defined with a plurality of sealing surfaces and communicating grooves along a press-in direction; the spacer group and the inner peripheral surface of an valve cavity of the valve body forms a plurality of gate grooves arranged along the press-in direction; the valve cavity is defined with a proximal cavity and a distal cavity respectively adjacent to the proximal end and the distal end of the spacer group along the press-in direction.

### CROSS-REFERENCE TO RELATED APPLICATIONS

This application claims a priority to and benefits of Chinese Patent Application Serial No. 201820948457.9, 201820641563.2, 201820641932.8, 201810408342.5, 201820646191.2, 201810409439.8 and 201820639367.1, filed with the State Intellectual Property Office of P. R. China on Apr. 28, 2018, the entire contents of which are incorporated herein by reference.

### FIELD

The present disclosure relates to the field of water purification technology, and more particularly relates to a water softener valve and a water softener.

### BACKGROUND

A water softener can soften the water, thereby improving the users' water quality experience, saving detergent, saving water and so on. A core component of the water softener is water softener valve. The water softener valve has the function of switching different water passages among water purification, backwashing, salt suction regeneration, forward washing, and water injection, which can be achieved by controlling a main piston of a multi-way valve connected to a piston rod to reciprocate. To realize salt suction forward washing, a traditional piston body is designed to include two separable components, so as to communicate corresponding waterways by water diversion in the cavity of the piston body, in which the connection and cooperation between the piston rod and the piston body are complex, and the precision required for the cooperation with the corresponding spacer group is high, which results in a high producing and processing cost.

### SUMMARY

One embodiment of the present disclosure to provide a water softener valve, aiming to solve the problem that the structure of the existing water softener valve is complex and the assembly of the existing water softener valve is complicated for a salt suction forward washing.

As such, the present disclosure provides a water softener valve. The water softener valve includes a valve body, a spacer group and a piston assembly, the piston assembly includes a piston body and a piston rod.

The piston assembly is defined with a water passage having both ends through, and the outer peripheral surface of the piston body is alternately defined with a plurality of sealing surfaces and communicating grooves along a press-in direction; the spacer group and the inner peripheral surface of an valve cavity of the valve body forms a plurality of gate grooves arranged along the press-in direction;

the valve cavity is defined with a proximal cavity and a distal cavity respectively adjacent to the proximal end and the distal end of the spacer group in the press-in direction; the inner wall of the valve cavity corresponding to the plurality of gate grooves is defined with a water-inlet inner hole, a water-outlet inner hole, a forward washing water-inlet port, a forward washing jet flow hole, a softening inlet port and a wastewater inner hole, corresponding to the distal cavity is defined with a softening outlet port; the proximal cavity and the adjacent gate groove, two adjacent gate grooves, and the gate groove and the adjacent distal cavity, are blocked by a corresponding sealing surface or communicated by a corresponding communication groove.

In one embodiment, the inner wall of the valve cavity corresponding to the plurality of gate grooves is further defined with a backwashing water-inlet port, and corresponding to the distal cavity is defined with a backwashing jet flow hole.

In one embodiment, during the backwashing condition, the water-inlet inner hole connects to the backwashing water-inlet port, the backwashing jet flow port connects to the softening outlet port, and the softening outlet port connects to the wastewater inner hole.

In one embodiment, the plurality of gate grooves includes a first gate groove, a fourth gate groove, as well as a second gate groove and a third gate groove defined between the first gate groove and the fourth gate groove;

the proximal cavity is adjacent to the first gate groove, the distal cavity is adjacent to the fourth gate groove;

the inner wall of the valve cavity corresponding to the first gate groove is defined with the wastewater inner hole;

the inner wall surface corresponding to the second gate groove is defined with the forward washing jet hole and the softening inlet port;

the inner wall surface corresponding to the third gate groove is defined with the forward washing water-inlet port and the water-inlet inner hole; and

the inner wall surface corresponding to the fourth gate groove is defined with the backwashing water-inlet port and the water-outlet inner hole.

In one embodiment, the plurality of sealing surfaces includes a first sealing surface, a second sealing surface and a third sealing surface, the plurality of communicating grooves includes a first communicating groove and a second communicating groove;

the first sealing surface, the first communicating groove, the second sealing surface, the second communicating groove and the third sealing surface are sequentially arranged along the press-in direction; and the first gate groove, the second gate groove, the third gate groove and the fourth gate groove are sequentially arranged along the press-in direction.

In one embodiment, the first gate groove, the second gate groove, the third gate groove and the fourth gate groove are all annular, the first sealing surface, the first communicating groove, the second sealing surface, the second communicating groove and the third sealing surface are all annular, and the first sealing surface, the second sealing surface and the third sealing surface are located in the same peripheral surface.

In one embodiment, the valve body includes a main body and a first end cap, the main body is defined with an inner cavity having one end open, the first end cap is covered at the opening of the valve body and enclosed with the valve body to form the valve cavity.

In one embodiment, the piston rod extends out of the valve body through the first end cap, the proximal cavity is adjacent to the first end cap, the valve cavity is defined with a bottom surface opposite to the first end cap;

the water softener valve further includes an irregular grid having a ring shape, the irregular grid is defined with a recess toward the bottom surface, the distal cavity is formed between the recess and the bottom surface; the spacer group is tightly pressed between the first end cap and the irregular grid.

In one embodiment, the piston rod is integrated, the piston assembly further includes a connecting member and a fastening member, the connecting member is disposed on the piston rod, the connecting member and the piston rod are in a position-limiting cooperation in the telescopic direction of the piston rod, and the fastening member is cooperated with the piston body to limit the connecting member in the telescopic direction.

In one embodiment, the piston body is integrally injection molded, the piston body is defined with a cavity extending along the telescopic direction and having both ends through, the inner wall of the inner cavity is defined with a stepped surface;

the outer peripheral surface of the piston rod is provided with an via hole, the connecting member has an elongated shape and is disposed through the via hole; the fastening member is arranged in a ring shape and embedded in the cavity, the annular space defined between the inner annular surface of the fastening member and the outer peripheral surface of the piston rod communicates with the cavity, the connector is clamped between the stepped surface and the fastening member.

In one embodiment, the water softener valve includes a driving mechanism, the driving mechanism includes a mounting seat and a cam, the end of the piston rod extending out the valve body is in a transmission cooperation with the cam;

the mounting seat is defined with a sliding connection structure, the end of the piston rod extending out the valve body is defined with a sliding cooperation portion, the sliding cooperation portion is slidably cooperated with the sliding connection structure along a longitudinal direction, and the sliding cooperation portion is in a position-limiting cooperation with the sliding connection structure along a lateral direction;

the sliding connection structure includes two opposite slideways in the lateral direction, and the sliding cooperation portion extends between the two slideways and is slidably cooperated with the two slideways along the longitudinal direction respectively;

the longitudinal direction coincides with the length direction of the piston rod, the lateral direction is perpendicular to the longitudinal direction and the axial direction of the cam.

In one embodiment, the piston rod includes a rod portion and a transmission cooperation portion defined on one end of the rod portion, the transmission cooperation portion is defined on the outer side of the valve body, the sliding cooperation portion includes a plurality of sliding shafts defined on the side of the transmission cooperation portion facing away from the cam, the plurality of sliding shafts are arranged in two rows respectively slidably cooperated with the two slideways along the longitudinal direction.

In one embodiment, the transmission cooperation portion protrudes from the peripheral surface of the rod portion in the lateral direction, the transmission cooperation portion is defined with a sliding groove extending along the longitudinal direction, the cam is defined with an eccentric shaft adapted to the sliding groove, and the plurality of sliding shafts are defined at the periphery of the sliding groove.

In one embodiment, each of the two rows of sliding shafts is disposed on the side of the sliding groove facing away from the valve body;

the axis of the sliding shaft that the sliding shaft presses one of the slideways when the eccentric shaft presses the groove wall of the sliding groove facing away from the valve body,

is further away from the valve body in the longitudinal direction than the axis of the sliding shaft that the sliding shaft presses the other of the slideways when the eccentric shaft presses the groove wall of the sliding groove facing close to the valve body.

In one embodiment, the mounting seat includes a first mounting plate, the sliding connection structure includes two parallel ribs disposed on the side of the first mounting facing the piston rod, the ribs extend along the longitudinal direction, and the two slideways are formed on the side of the two ribs facing with each other.

In one embodiment, the side of the rod portion facing the cam is flush with the side of the transmission cooperation portion facing the cam, the transmission cooperation portion is in a gap cooperation with the side facing the cam; the side the rod portion facing away from the cam protrudes from the side of the transmission cooperation portion facing away from the cam.

The side of the first mounting plate facing the cam is provided with a fixing post. A fixing hole penetrating the first mounting plate is disposed in the fixing post, and the end of the fixing post adjacent to the transmission cooperation portion is provided with a notch to avoid the rod portion.

In one embodiment, the driving mechanism further includes a covering plate which covers the mounting seat, the cam and the piston rod are disposed between the covering plate and the mounting seat.

The outer peripheral surface of the cam is provided with a ring gear. The driving mechanism further includes a speed reducer group disposed on the side of the first mounting plate facing away from the covering plate, the first mounting plate is provided with an via hole, an output shaft of the speed reducer group passes through the via hole and cooperates with the ring gear on the outer circumference of the cam.

In one embodiment, the mounting seat further includes a connecting plate and a second mounting plate, the connecting plate extends from one side of the first mounting plate and away from the cam, the second mounting plate extends from the edge of the connecting plate away from the cam, along the lateral direction, and away from second mounting plate;

the first mounting plate and the connecting plate are enclosed to form a mounting recess for mounting the speed reducer group, a first mounting cavity is formed between the first mounting plate and the covering plate, a second mounting cavity is formed between the connecting plate, the second mounting plate and the covering plate, the cam is located in the first mounting cavity.

In one embodiment, the valve body includes a main body and a first end cap, the main body is defined with a inner cavity having one end open, the first end cap is covered with the opening of the valve cavity, the first end cap is defined with a mounting hole for the piston rod to extend out the valve body, the mounting seat and the covering plated are fixedly mounted on the end cap.

In one embodiment, the water softener valve includes:

a control box, comprising a housing assembly and a transmission mechanism, the housing assembly being configured to connect to the valve body of the water softener valve, the transmission mechanism comprising a driving member movably mounted in the housing assembly, the driving member being configured to connect to the piston rod, to drive the piston rod to move, the driving member being defined with an inductive structure;

an electronic control board, mounted in the housing assembly, the electronic control board being defined with a plurality of inductors, the plurality of inductors being configured to sense the inductive structure, and output corresponding electronic signal when the inductive structure moving into inductive area of the inductors.

In one embodiment, the driving member is rotatably connected to the housing assembly, the plurality of inductors are distributed around the rotation axis of the driving member.

In one embodiment, the transmission mechanism further includes a transmission gear, the transmission gear is configured to connect to a motor of the water softener valve, the driving member includes a cam, the outer peripheral surface of the cam is defined with gear rings, the gear rings cooperates with the transmission gear, and the cam is configured to connect to the piston rod, to drive the piston rod to move;

the electronic control board is defined on the side of the gear rings facing away from the cam, the inductive structure is defined on the cam, and the inductors are defined on the side of the electronic control board facing the gear rings.

In one embodiment, the housing assembly is defined with a positioning post therein, an positioning hole is opened at the position of the electronic control board corresponding to the positioning post. The positioning post is inserted into the positioning hole, to limit the movement of the electronic control board along the radial direction of the positioning post.

In one embodiment, the housing assembly includes a mounting seat and a covering plate arranged along the length direction of the positioning post, the electronic control board is located between the mounting seat and the covering plate, and the electronic control board is provided with a positioning portion, the thickness of the positioning portion in the length direction of the positioning post is equivalent to the distance between the covering plate and the mounting seat.

In one embodiment, the side of the covering plate facing the electronic control board is provided with a mounting dent, the electronic control board is mounted in the mounting dent, and the shape of the electronic control board is adapted to that of the mounting dent.

In one embodiment, the electronic control board is opposite to the driving member, the side of the electronic control board facing the driving member is defined with a receiving dent, and at least part of the driving member is received in the receiving dent; and/or

the side of the electronic control board facing the transmission mechanism is defined with an avoiding area, the avoiding area and the transmission mechanism are facing each other, the electronic control board is provided with an external connector, the external connector is disposed outside the avoiding area.

In one embodiment, the housing assembly is further defined with an isolation portion, the isolation portion connects to the inner wall of the housing assembly and/or the electronic control board; the isolation portion is defined on the side of the electronic control board facing the transmission mechanism, and between the transmission mechanism and the external connector, to isolate the transmission mechanism and the external connector.

In one embodiment, the external connector includes a main control board connector, the main control board connector is configured to be electrically connected to a main control board of the water softener;

the external connector further includes a motor connector, the motor connector is configured to be electrically connected to a motor of the water softener valve; and/or

the external connector further includes a flow inductor connector, the flow inductor connector is configured to be connected to a flow inductor of the water softener.

In one embodiment, the inductive structure includes a magnetic member, and the inductor includes a Hall element.

In one embodiment, the valve body includes a water-inlet passage, a water-outlet passage, a softening-inlet passage, a softening-outlet passage, a wastewater passage and a salt suction passage communicated with the valve cavity. The valve cavity, the water-inlet passage and the wastewater passage all extend along the first direction, the valve body is provided with a first end surface in the second direction, the water-inlet passage and the wastewater passage are both disposed adjacent to the first end surface. The first end surface is defined with a first flow guiding hole communicating with the water-inlet passage, and a second flow guiding hole communicating with the wastewater passage. The first direction is perpendicular to the second direction. The water softener valve further includes a second end cap configured to cover the first flow guiding hole and the second flow guiding hole.

In one embodiment, the side of the second end cap cooperated with the first end surface, corresponding to the first flow guiding hole and the second flow guiding hole, is respectively provided with a first flange and a second flange, the first flange and the inner wall of the first flow guiding hole are in a sealing cooperation, the second flange and the inner wall of the second flow guiding hole are in a sealing cooperation.

In one embodiment, a fourth sealing ring and a fifth sealing ring are further provided. The first flange is provided with a first annual groove for the fourth sealing ring to be sleeved with, and second flange is provided with a second annual groove for the fifth sealing ring to be sleeved with.

In one embodiment, the valve body is provided with a second end surface in the first direction. The water-inlet passage and the wastewater passage are respectively provided with a water-inlet port and a wastewater port on the second end surface, the cross-sectional dimension of the water-inlet port is larger than that of the wastewater port, the aperture of the first flow guiding hole is larger than that of the second flow guiding hole.

In one embodiment, the second end cap is detachably fixed on the first end surface.

In one embodiment, the first end surface is provided with a plurality of third fixing holes on the outer circumference edge adjacent to the first guiding hole and the second flow guiding hole. The second end cap corresponding to the third fixing holes is provided with through holes, the third fixing holes and the through holes are connected by the fastening member to lock the second end cap and the valve body.

In one embodiment, the number of the third fixing hole is three, including the first sub-fixing hole, the second sub-fixing hole and the third sub-fixing hole. The first sub-fixing hole is defined between the first flow guiding hole and the second flow guiding hole, the second sub-fixing hole is defined on the outer peripheral edge of the first flow guiding hole away from the first sub-fixing hole, and the third sub-fixing hole is defined on the outer peripheral edge of the second flow guiding hole away from the first sub-fixing hole. The third end cap, corresponding to the first sub-fixing hole, the second sub-fixing hole and the third sub-fixing hole, is respectively defined with a first through hole, a second through hole and a third through hole.

In one embodiment, the outer peripheral surface of the second end cap located between the second through hole and the third through hole is defined with a second recess.

In one embodiment, the first flow guiding hole is disposed adjacent to the second flow guiding hole, and the axes of the first flow guiding hole and the second flow guiding hole are staggered both in the first direction and the third direction, the first direction is perpendicular to the third direction.

In one embodiment, the valve body includes a water-inlet passage, a water-outlet passage, a softening-inlet passage, a softening-outlet passage, a wastewater passage and a salt suction passage communicated with the valve cavity,

the valve cavity, the wastewater passage and the salt suction passage extend along a first direction, the valve body is defined with a second end surface in the first direction, the wastewater passage and the sort suction passage respectively form a wastewater port and a salt suction port on the second end surface;

the softening-outlet passage extends perpendicular to the first direction, the second end surface is defined with a third flow guiding hole, the third flow guiding hole extends along the first direction and communicates with the softening-outlet passage;

the water softener valve further includes a wastewater drain nozzle defined at the wastewater port, a water injection salt suction nozzle defined at the salt suction port, and a third end cap detachably covered at the third flow guiding hole, the third end cap is further configured, together with the valve body, to limit the wastewater drain nozzle and the water injection salt suction nozzle.

In one embodiment, the side of the third end cap facing the second end surface is provided with a third flange sealingly mated with the third flow guiding hole.

In one embodiment, the outer peripheral surface of the third flange is provided with a third annular groove, and the water softener valve further includes a first sealing ring sleeved in the third annular groove and sealingly mated with the inner wall of the flow guiding hole.

In one embodiment, the third end cap corresponding to the wastewater port is provided with a first fixing hole for the wastewater drain nozzle; the third end cap corresponding to the salt suction port is provided with a second fixing hole for the water injection salt suction nozzle to be disposed through.

In one embodiment, the outer peripheral surface of the wastewater drain nozzle is stepped taper set, and provided with a first stepped surface facing the third end cap, an inner peripheral wall of the first fixing hole is provided with a first limiting surface to be in an abutting cooperation the first stepped surface.

In one embodiment, the outer peripheral surface of the water injection salt suction nozzle is stepped taper set, and provided with a second stepped surface facing the third end cap, the inner peripheral wall of the second fixing hole is provided with a second limiting surface to be in an abutting cooperation with the second stepped surface.

In one embodiment, the water softener valve further includes a second sealing ring and a third sealing ring. The second sealing ring is sleeved on the outer peripheral surface of the wastewater drain nozzle, and sealingly mated with inner wall of the wastewater port. The third sealing ring is sleeved on the outer peripheral surface of the salt suction port, and sealingly mated with inner wall of the water injection salt suction nozzle.

In one embodiment, the water-inlet passage and the water-outlet passage both extend along the first direction, the water-inlet passage and the water-outlet passage are respectively provided with a water-inlet port and a water-outlet port on the second end surface. The water-inlet port and the water-outlet port are arranged side by side along the second direction. The wastewater port, the third flow guiding hole and the salt suction port are arranged side by side along the second direction, and the wastewater port, the flow guiding hole and the salt suction port are located on the same side of the water-inlet port and the water-outlet port in the third direction. The first direction, the second direction and the third directions are perpendicular to each other

In one embodiment, the third flow guiding hole is located between the wastewater port and the salt suction port, the second end surface is provided with a first mounting hole, a second mounting hole and a third mounting hole, the first mounting hole is located between the water-inlet port and the water-outlet port, the second mounting hole is located between the wastewater port and the third flow guiding hole, the third mounting hole is located between the third flow guiding hole and the salt suction port, the third end cap corresponding to the first mounting hole, the second mounting hole and the third mounting hole is respectively provided with a first assembling hole, a second assembling hole and a third assembling hole.

The present disclosure also provides a water softener, the water softener includes an ion exchange tank, a salt box, and the said water softener valve. The water softener valve includes a valve body, a spacer group and a piston assembly, the piston assembly includes a piston body and a piston rod.

The piston assembly is defined with a water passage with both ends through, the outer peripheral surface of the piston body is alternately defined with a plurality of sealing surfaces and communicating grooves along a press-in direction; the spacer group and the inner peripheral surface of an valve cavity of the valve body forms a plurality of gate grooves arranged along the press-in direction;

The valve cavity is defined with a proximal cavity and a distal cavity respectively adjacent to the proximal end and the distal end of the spacer group in the press-in direction; the inner wall of the valve cavity corresponding to the plurality of gate grooves is defined with a water-inlet inner hole, a water-outlet inner hole, a forward washing water-inlet port, a forward washing jet flow hole, a softening inlet port and a wastewater inner hole, corresponding to the distal cavity is defined with a softening outlet port; the adjacent proximal cavity and the gate groove, two adjacent gate grooves, and the gate groove and the adjacent distal cavity, are blocked by a corresponding sealing surface or communicated by a corresponding communication groove.

In the water softener valve according to the present disclosure, the piston assembly is provided with a water passage having both ends through, during the forward washing condition, the water-inlet inner hole communicates with the forward washing water-inlet port, the forward washing jet flow hole communicates with the softening inlet port, the softening outlet port communicates with the distal cavity, the proximal cavity communicates with the wastewater inner hole, and the water passage communicates with the proximal cavity and the distal cavity. That is, during the forward washing condition, there is no need to split the piston body into two separated parts, to realize the communicating of the corresponding waterway. The water softener valve of an embodiment fully utilizes the internal space of the piston assembly, and improves the cooperation relationship between the piston assembly and the valve body, realizing waterway switching of the forward washing condition with a simple structure. And the assembly is simple, the production cost is low.

### BRIEF DESCRIPTION OF THE DRAWINGS

In order to more clearly illustrate the embodiments of the present disclosure, the drawings used in the embodiments will be briefly introduced below.

FIG. 1 is a structure view of a water softener valve of an embodiment according to the present disclosure, in which the driving mechanism is omitted;

FIG. 2 is a partially exploded perspective view of the water softener valve in FIG. 1;

FIG. 3 is a right view of the water softener valve FIG. 1;

FIG. 4 is a cross-sectional structure view of FIG. 3 along line IV-IV;

FIG. 5 is a structure view of the main body of the water softener valve in FIG. 1;

FIG. 6 is a cross-sectional structure view of FIG. 5 along line VI-VI;

FIG. 7 is a cross-sectional structure view of FIG. 5 along line VII-VII;

FIG. 8 is a cross-sectional structure view of FIG. 5 along line VIII-VIII;

FIG. 9 is a bottom view of the main body in FIG. 5;

FIG. 10 is a structure view showing the cooperation of the end cap and the piston assembly of the water softener valve in FIG. 1;

FIG. 11 is a cross-sectional structure view of the piston body in FIG. 10;

FIG. 12 is a structure view of a water softener of an embodiment according to the present disclosure;

FIG. 13 is a partial enlarged view of A as shown in FIG. 12, in which the water softener valve is in forward washing condition;

FIG. 14 is a partial enlarged view of A as shown in FIG. 12, in which the water softener valve is in backwashing condition;

FIG. 15 is a partial enlarged view of A as shown in FIG. 12, in which the water softener valve is in water producing condition;

FIG. 16 is a partial enlarged view of A as shown in FIG. 12, in which the water softener valve is in water injection condition;

FIG. 17 is an overall structure view of the water softener valve according to the present disclosure;

FIG. 18 is an exploded structure view of the water softener valve in FIG. 17;

FIG. 19 is a structure view showing the cooperation of the piston rod, the components of the driving mechanism and the end cap in FIG. 18;

FIG. 20 is an partially exploded structure view of the structure in FIG. 19;

FIG. 21 is a structure view showing the cooperation of the end cap, the cam and the piston rod in FIG. 20;

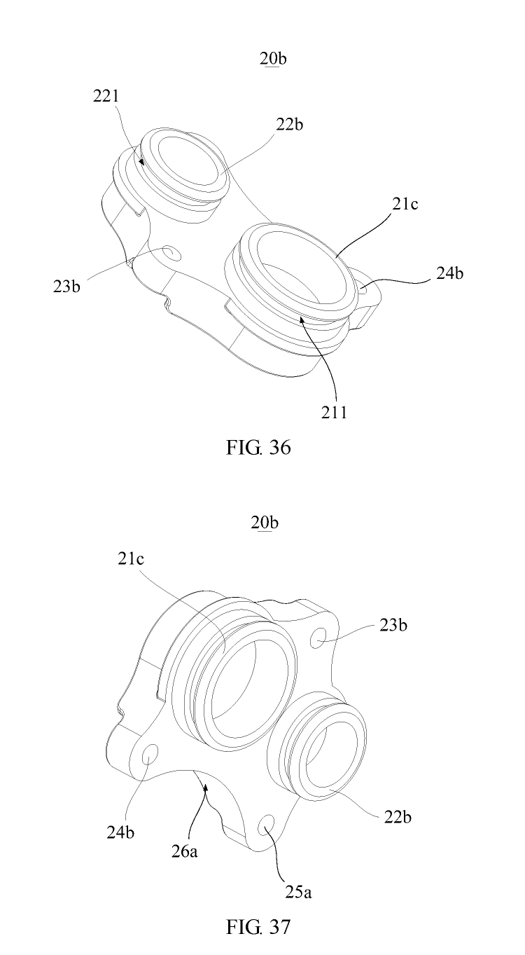

FIG. 22 is a structure view showing the cooperation of the cam and the piston rod in FIG. 21;

FIG. 23 is an inner structure view of the mounting seat in FIG. 20;

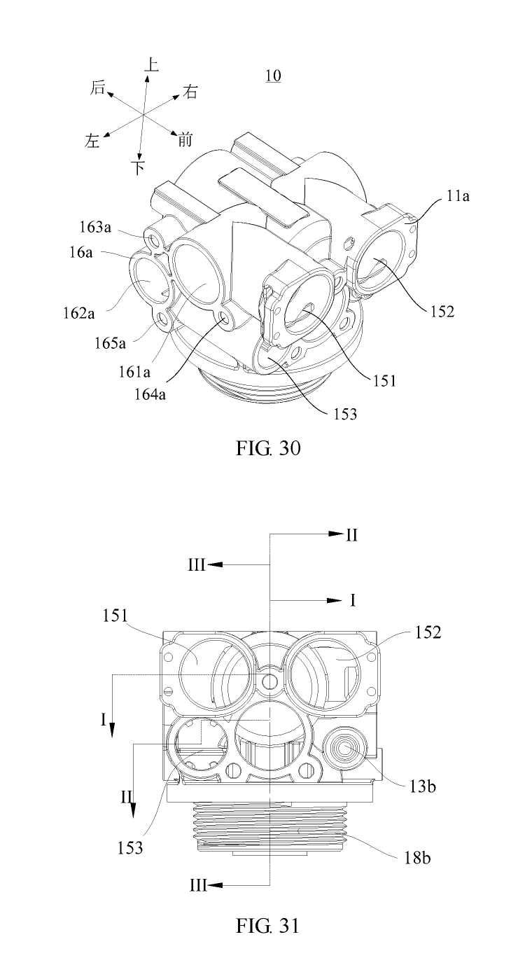

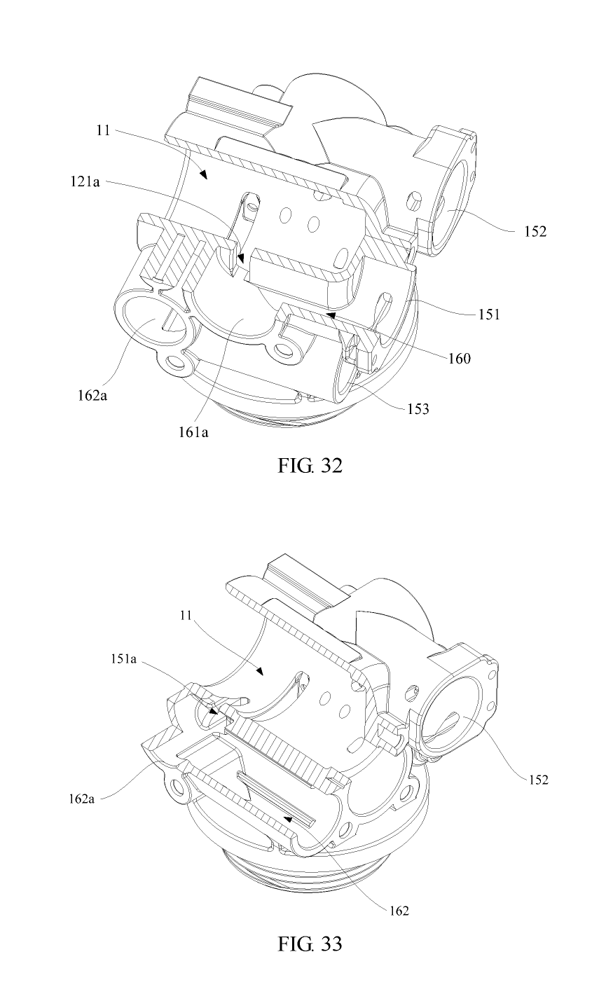

FIG. 19 is a top view showing the cooperation of the piston rod, the components of the driving mechanism and the end cap in FIG. 18;

FIG. 25 is a cross-sectional structure view of FIG. 24 along line XI-XI;

FIG. 26 is a cross-sectional structure view of FIG. 24 along line XII-XII;

FIG. 27 is a structure view of the transmission mechanism, the electronic control board and the first housing according to the present disclosure after assembly;

FIG. 28 is a structure view of an electronic control board of an embodiment according to the present disclosure;

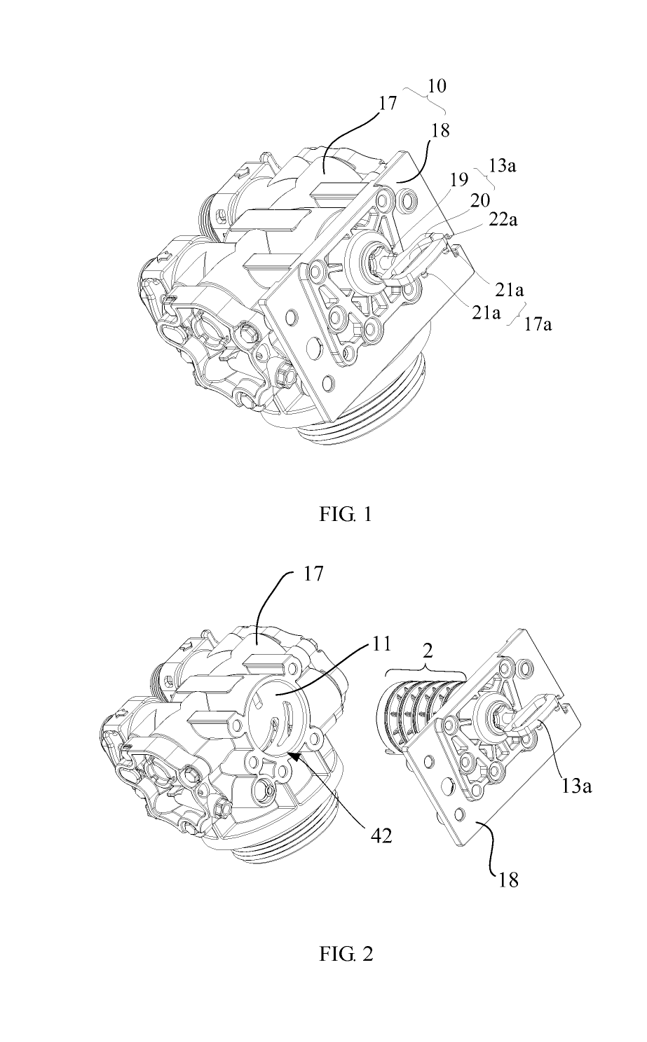

FIG. 29 is another perspective view of the water softener valve in FIG. 1;

FIG. 30 is a structure view of the valve body in FIG. 29;

FIG. 31 is a front view of the valve body in FIG. 30;

FIG. 32 is a cross-sectional structure view of the valve body in FIG. 31 along line I-I;

FIG. 33 is a cross-sectional structure view of the valve body in FIG. 31 along line II-II;

FIG. 34 is a cross-sectional structure view of the valve body in FIG. 31 along line III-III;

FIG. 35 is a left view of the water softener valve as shown in FIG. 29 with the second end cap removed;

FIG. 36 is a structure view of a second end cap of an embodiment;

FIG. 37 is another perspective view of the second end cap in FIG. 36;

FIG. 38 is a partially exploded structure view of the water softener valve of the present disclosure;

FIG. 39 is a front view of the water softener valve according to the present disclosure;

FIG. 40 is a rear structure view of a third end cap of an embodiment according to the present disclosure;

FIG. 41 is a perspective view of the third end cap in FIG. 40.

### DESCRIPTION OF THE REFERENCE SIGNS

| sign | name |
|---|---|
| 100 | water softener valve |
| 10 | valve body |
| 11 | valve cavity |
| 12 | proximal cavity |
| 13 | distal cavity |
| 141 | water-inlet inner hole |
| 142 | water-outlet inner hole |
| 143 | forward washing water-inlet port |
| 144 | forward washing jet flow hole |
| 145 | softening inlet port |
| 146 | wastewater inner hole |
| 147 | softening outlet port |
| 148 | backwashing water-inlet port |
| 149 | backwashing jet flow port |
| 151 | water-inlet port |
| 152 | water-outlet port |
| 153 | wastewater port |
| 160 | water-inlet passage |
| 42 | opening |
| 13a | piston rod |
| 17a | sliding cooperation portion |
| 21a | sliding shaft |
| 19 | rod portion |
| 20 | transmission cooperation portion |
| 22a | sliding groove |
| 12a | driving mechanism |
| 14 | mounting seat |
| 100a | control box |
| 110 | housing assembly |
| 111 | positioning post |
| 114 | mounting dent |
| 120 | transmission mechanism |
| 121 | driving member |
| 122 | inductive structure |
| 121a | first communicating hole |
| 151a | second communicating hole |
| 16a | first end surface |
| 161a | first flow guiding hole |
| 162a | second flow guiding hole |
| 163a | first sub-fixing hole |
| 164a | second sub-fixing hole |
| 11a | second end surface |
| 111a | first mounting hole |
| 112a | second mounting hole |
| 113a | third mounting hole |
| 13b | salt suction port |
| 14a | third flow guiding hole |
| 20a | wastewater drain nozzle |
| 21b | first stepped surface |
| 161 | water-outlet passage |
| 162 | wastewater passage |
| 163 | softening-inlet passage |
| 164 | softening-outlet passage |
| 165 | forward washing jet flow passage |
| 166 | forward washing water-inlet passage |
| 167 | backwashing jet flow passage |
| 168 | backwashing water-inlet passage |
| 169 | salt suction water injection passage |
| 17 | main body |
| 18 | first end cap |
| 2 | spacer group |
| 21 | first gate groove |
| 22 | second gate groove |
| 23 | third gate groove |
| 24 | fourth gate groove |
| 3 | piston assembly |
| 31 | piston body |
| 16 | sliding connection structure |
| 18a | slideway |
| 25 | rib |
| 24a | first mounting plate |
| 32a | via hole |
| 26 | fixing post |
| 27 | fixing hole |
| 28 | notch |
| 34 | first connecting plate |
| 123 | transmission gear |
| 200a | electronic control board |
| 201a | inductor |
| 202a | positioning hole |
| 203a | positioning portion |
| 204 | receiving dent |
| 205 | external connector |
| 165a | third sub-fixing hole |
| 18b | mounting head |
| 181 | first annular cylinder |
| 182 | second annular cylinder |
| 20b | second end cap |
| 21c | first flange |
| 211 | first annular groove |
| 30a | water injection salt suction nozzle |
| 31 | second stepped surface |
| 40 | third end cap |
| 41a | third flange |
| 411 | annular groove |
| 42a | first fixing hole |
| 43 | second fixing hole |
| 44 | first assembly hole |
| 31a | cavity |
| 32 | third stepped surface |
| 341 | first sealing surface |
| 342 | second sealing surface |
| 343 | third sealing surface |
| 351 | first communicating groove |
| 352 | second communicating groove |
| 36 | first connecting member |
| 37 | first fastening member |
| 4 | irregular grid |
| 41 | first recess |
| 200 | ion exchange tank |
| 201 | tank body |
| 202 | central tube |
| 203 | ion exchange chamber |
| 300 | salt box |
| 35 | second mounting plate |
| 36a | mounting recess |
| 37a | first mounting cavity |
| 38 | second mounting cavity |
| 29 | covering plate |
| 15 | cam |
| 23a | eccentric shaft |
| 30 | gear rings |
| 33a | output shaft |
| 206 | avoiding area |
| 207 | isolation portion |
| 208 | main control board connector |
| 209 | motor connector |
| 210 | flow inductor connector |
| 500 | power device |
| 22b | second flange |
| 221 | second annular groove |
| 23b | first through hole |
| 24b | second through hole |
| 25a | third through hole |
| 26a | second recess |
| 45 | second assembly hole |
| 46 | third assembly hole |
| 50 | first sealing ring |
| 60 | second sealing ring |
| 70 | third sealing ring |
| 80 | second fastening member |

T Embodiments of the present disclosure are further described in detail with reference to the accompanying drawings and the embodiments.

### DETAILED DESCRIPTION OF THE EMBODIMENTS

The technical solutions in the embodiments of the present disclosure are clearly and completely described in the following with reference to the accompanying drawings in the embodiments of the present disclosure. It will be appreciated that the described embodiments are merely part of the embodiments of the present disclosure, rather than all the embodiments.

It should be noted that, if there is a directional indication (such as up, down, left, right, front, back, . . . ) in the embodiment of the present disclosure, the directional indication is merely used to explain, in a certain posture (as shown in the drawing), relative positional relationship, movement and so on between parts. If the certain posture changes, the directional indication changes correspondingly.

The present disclosure provides a water softener valve.

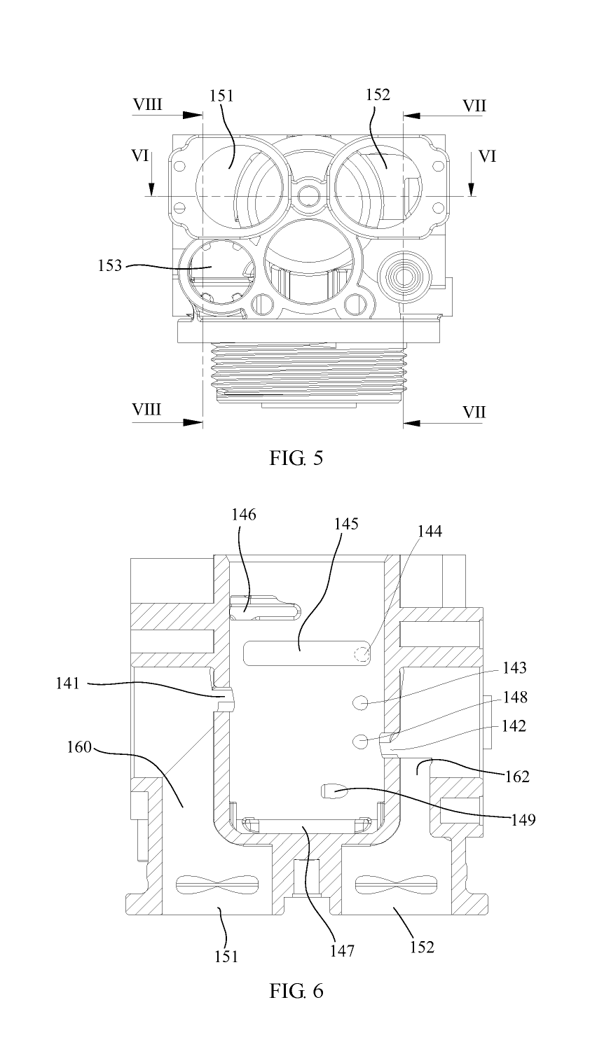

In one embodiment of the present disclosure, as shown in FIG. 1-4, 6, 12 and 13, the water softener valve 100 includes a valve body 10, a spacer group 2 and a piston assembly 3. The piston assembly 3 includes a piston body 31 and a piston rod 13a.

The piston assembly 3 is provided with a water passage having both ends through, the outer peripheral surface of the piston body 31 is alternately provided with a plurality of sealing surfaces and communicating grooves along the press-in direction. The spacer group 2 and the inner peripheral surface of an valve cavity 11 of the valve body 10 forms a plurality of gate grooves arranged along the press-in direction.

The valve cavity 11 is provided with a proximal cavity 12 and a distal cavity 13 respectively adjacent to the proximal end and the distal end of the spacer group in the press-in direction. The inner wall of the valve cavity 11, corresponding to the plurality of gate grooves, is provided with a water-inlet inner hole 141, a water-outlet inner hole 142, a forward washing water-inlet port 143, a forward washing jet flow hole 144, a softening inlet port 145 and a wastewater inner hole 146; the inner wall of the valve cavity 11, corresponding to the distal cavity 13, is provided with a softening outlet port 147. The proximal cavity 12 and the gate groove, two gate grooves, as well as the gate groove and the distal cavity 13, which are adjacent to each other, are blocked by a corresponding sealing surface or communicated by a corresponding communication groove.

In some embodiments, the valve body 10 is formed by a plurality of components fastened via bolts, and the cooperation surfaces being in a sealing cooperation with a sealing ring or the like. To facilitate mass production, each component may be injection molded. In some other embodiments, the valve body 10 is formed by a plurality of components connected together by ultrasonic welding, to form a relatively complicated valve cavity 11 and each passage. Or, in some other embodiments, the valve body 10 is manufactured by using emerging 3D printing technology, to facilitate small batch models.

The plurality of gate grooves are usually formed by similar structural members assembled. And in order to be fixed along the press-in and pull-out directions of the piston rod 13a, these structural members, in addition to partition plates, are provided with a support rod connected between the opposite partition plates, to form a grid-shaped gate groove. In order to better isolate adjacent gate grooves, a sealing member is further provided between adjacent structural members, usually the sealing member is annular and extends inwardly out of the inner edge of the partition plate of the structural member.

In the piston assembly 3, the piston body 31 reciprocates to realize waterway switching of corresponding function, such as water production, suction salt forward washing, suction salt backwashing, and injection waterway of the salt box 300. The piston rod 13a mainly functions as a transmission, the inner tank of the piston rod 13a connects to the piston body 31, and the outer connects to the driving mechanism. The driving mechanism is configured to realize the automatic waterway switching, usually uses a gear and a cam group.

The water-inlet inner hole 141, the water-outlet inner hole 142, the forward washing water-inlet port 143, the forward washing jet flow hole 144, the softening inlet port 145 and the wastewater inner hole 146 may be in different arrangements. It should be understood that, every two of the water-inlet inner hole 141, the water-outlet inner hole 142 and the wastewater inner hole 146 are in different gate grooves, namely communicate with different gate grooves. Similarly, the forward washing water-inlet port 143 and the forward washing jet flow hole 144 are respectively disposed in different gate grooves. In addition to this, there are many combinations.

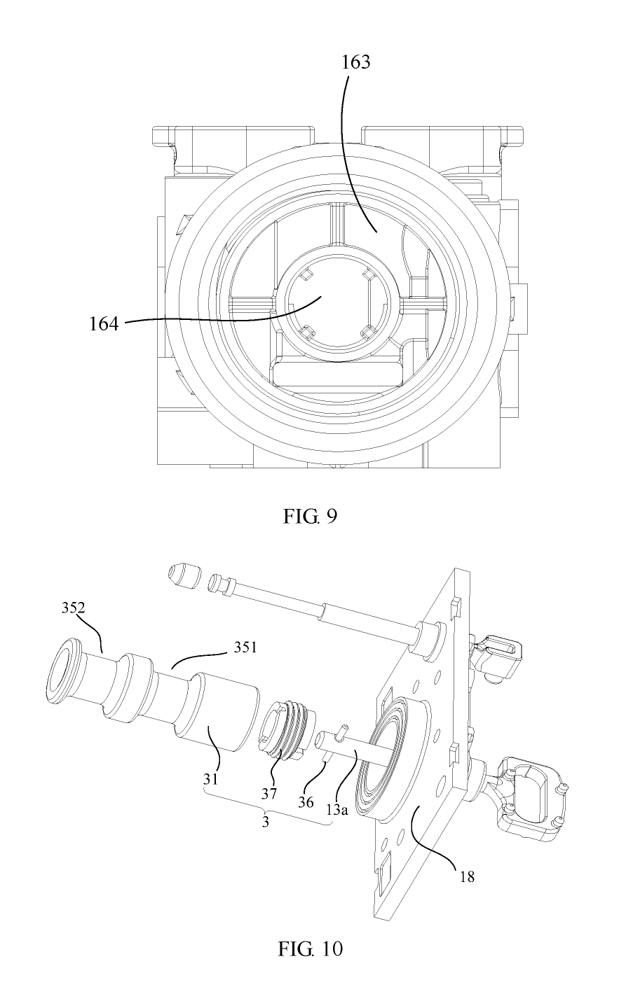

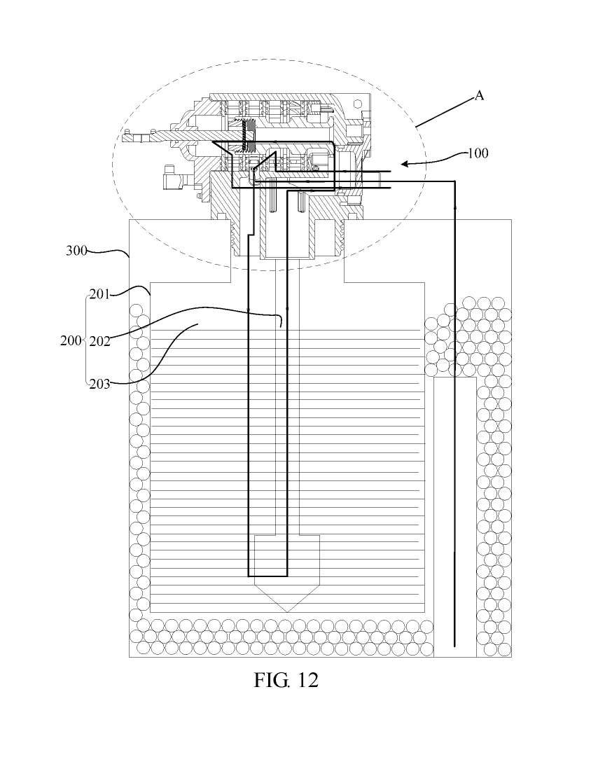

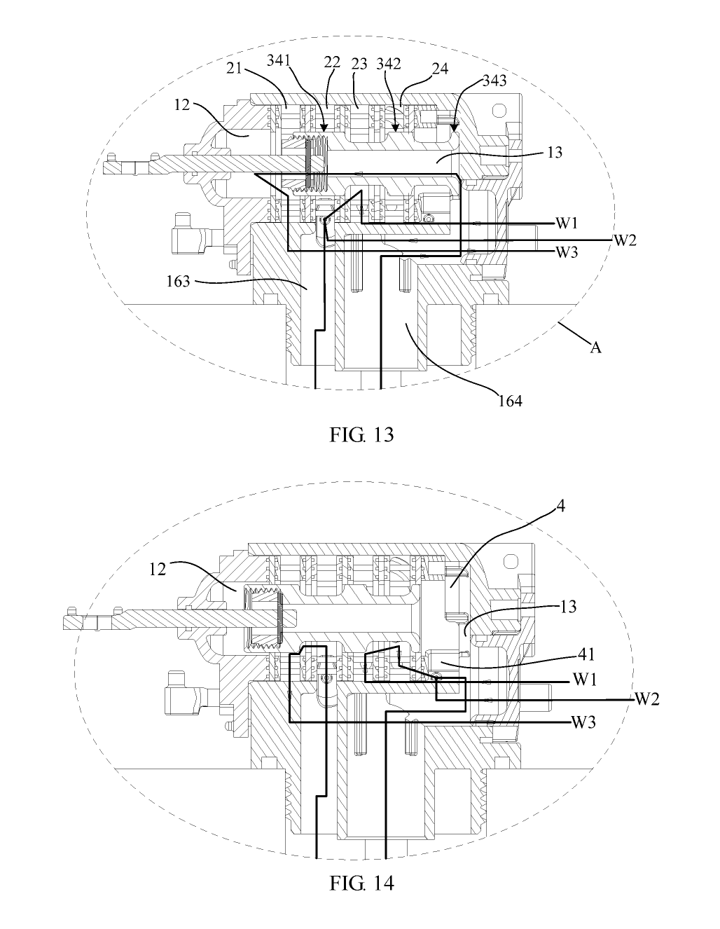

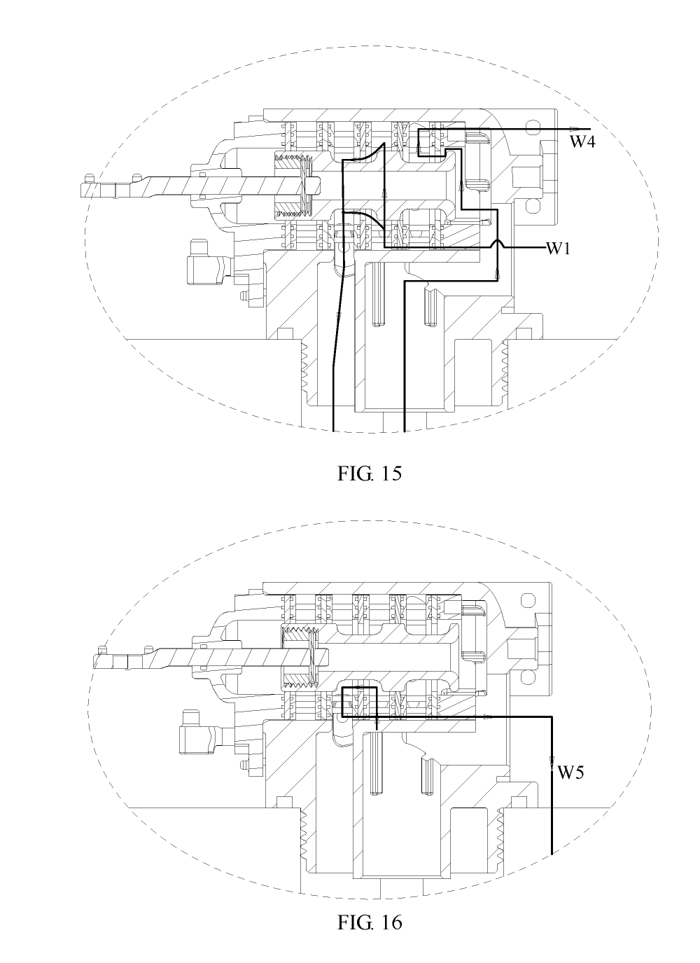

It should be understood that, referring to FIG. 5-9, specifically, the outside of the valve body 10 is provided with a water-inlet port 151, a water-outlet port 152 and a wastewater port 153, the inside is provided with:

a water-inlet passage 160 communicating the water-inlet inner hole 141 with the water-inlet port 151,

a water-outlet passage 161 communicating the water-outlet inner hole 142 with the water-outlet port 152,

a wastewater passage 162 communicating the wastewater inner hole 146 with the wastewater port 153,

a softening-inlet passage 163 communicating the softening inlet port 145 with the ion exchange chamber 203, and

a softening-outlet passage 164 communicating the softening outlet port 147 with the central tube 202.

Similarly, the inside of the valve body 10 is further provided with: a forward washing jet flow passage 165 communicating the forward washing jet flow hole 144 with the salt suction water injection passage 169, a forward washing water-inlet passage 166 communicating the forward washing water-inlet port 143 with the salt suction water injection passage 169, a backwashing jet flow passage 167 communicating the backwashing jet flow hole with the salt suction water injection passage 169, a backwashing water-inlet passage 168 communicating the backwashing jet flow hole with the salt suction water injection passage 169. It should be understood that, during the switching between the forward washing and the backwashing, the forward washing water-inlet passage 166 and the backwashing water-inlet passage 168, as well as the forward washing jet flow passage 165 and the backwashing jet flow passage 167 are blocked by switching.

The position of each port and the shape or form of each passage are not to be limited herein.

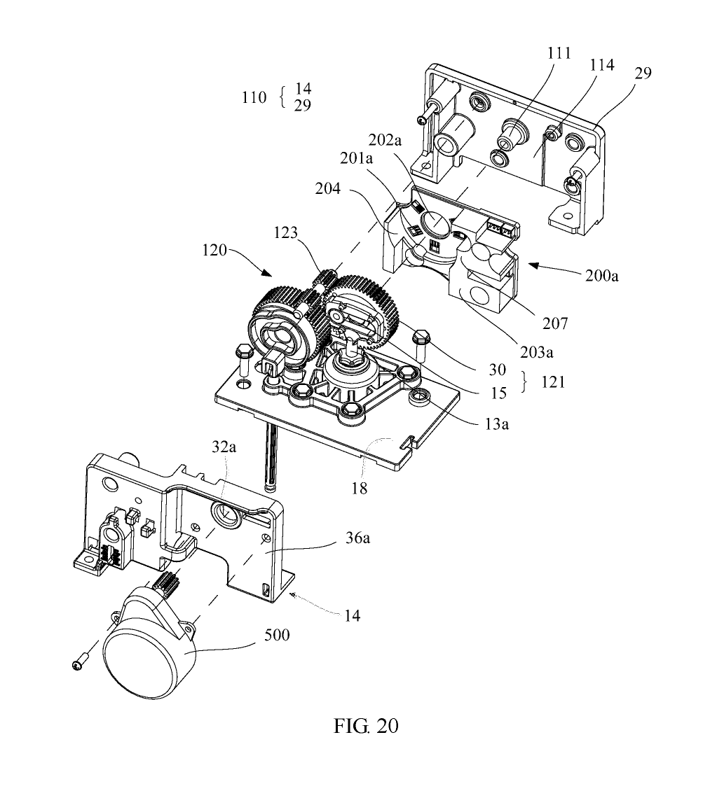

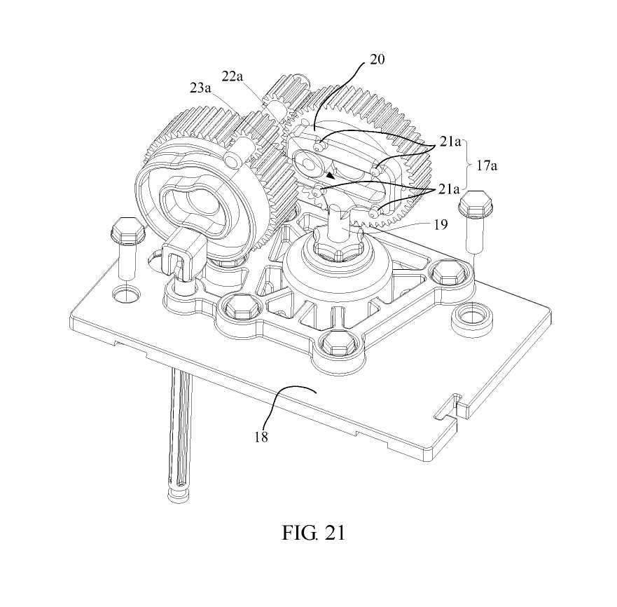

In the water softener valve according to the present disclosure, the piston assembly 3 is provided with a water passage having both ends through. During the forward washing condition, the water-inlet inner hole 141 communicates with the forward washing water-inlet port 143, the forward washing jet flow hole 144 communicates with the softening inlet port 145, the softening outlet port 147 communicates with the distal cavity 13, the proximal cavity 12 communicates with the wastewater inner hole 146, and the water passage communicates with the proximal cavity 12 and the distal cavity 13. That is, during the forward washing condition, there is no need to split the piston body 31 into two separated parts to realize the communicating of the corresponding waterways. Therefore, the water softener valve 100 fully utilizes the internal space of the piston assembly 3, and improves the cooperation relationship between the piston assembly 3 and the valve body 10, which realizes the waterway switching of the forward washing condition with a relatively simple structure, simplifying the assembly and reducing the production cost. Referring to FIG. 12 and FIG. 13, as shown by the arrow W1, the raw water passes through the water-inlet port 151, the water-inlet passage 160, the water-inlet inner hole 141, the gate groove communicating the water-inlet inner hole 141 with the forward washing water-inlet port 143, the forward washing water-inlet port 143, the forward washing water-inlet passage 166, and merges with the saline water of the salt suction water injection passage 169, as indicated by the arrow W2, at the intake of the forward washing jet flow passage 165; then the mixed saline solution, as indicated by the arrow W3, passes through the forward washing jet flow hole 144, the gate groove communicating the forward washing jet flow hole 144 with the softening inlet port 145, the softening inlet port 145, the softening-inlet passage 163, the ion exchange chamber 203, the central tube 202, the softening-outlet passage 164, the softening outlet port 147, the distal cavity 13, the water passage, the proximal cavity 12, the gate groove communicating the proximal cavity 12 with the wastewater inner hole 146, the wastewater inner hole 146 and the wastewater passage 162; finally is discharged from the wastewater port 153.

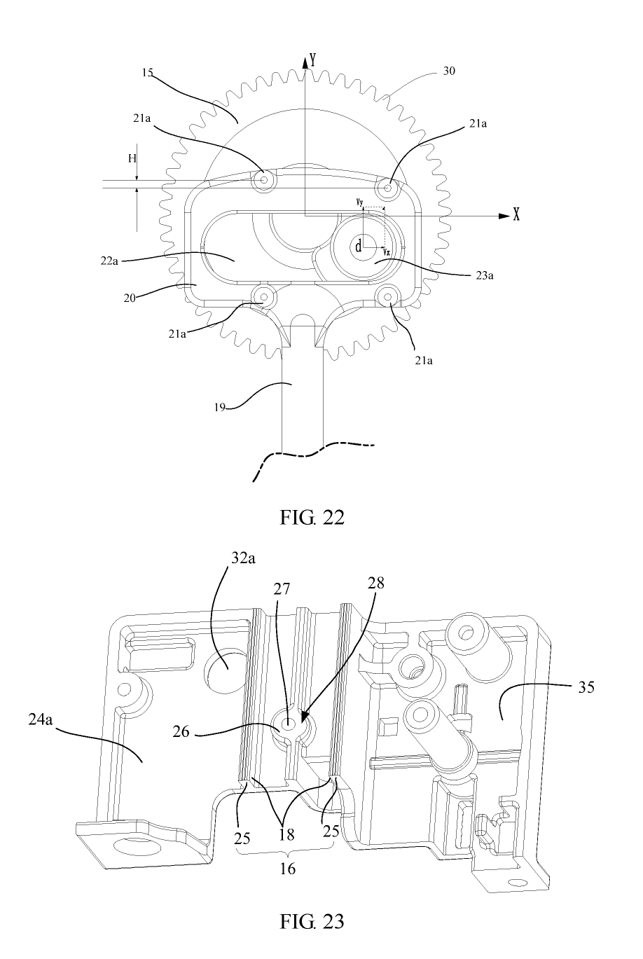

In some embodiments, the inner wall of the valve cavity 11 corresponding to the plurality of gate grooves is further provided with a backwashing water-inlet port 148, the inner wall of the valve cavity 11 corresponding to the distal cavity 13 is provided with a backwashing jet flow port 149, so that the water softener valve 100 can also integrally realize backwashing. Specifically, during the backwashing condition, the water-inlet inner hole 141 communicates with the backwashing water-inlet port 148, the backwashing jet flow port 149 communicates with the softening outlet port 147, and the softening inlet port 145 communicates with the wastewater inner hole 146. Referring to FIG. 14, first shown as the arrow W1, the raw water passes through the water-inlet port 151, the water-inlet passage 160, the water-inlet inner hole 141, the gate groove communicating the water-inlet inner hole 141 with the backwashing water-inlet port 148, the backwashing water-inlet port 148, the backwashing water-inlet passage 168, and merges with the saline water of the salt suction water injection passage 169, as indicated by the arrow W2, at the intake of the backwashing jet flow passage 167; then the mixed saline solution, as indicated by the arrow W3, passes through the backwashing jet flow hole, the distal cavity 13 communicating the backwashing jet flow hole with the softening outlet port 147, the softening outlet port 147, the softening-outlet passage 164, the central tube 202, the softening-inlet passage 163, the ion exchange chamber 203, the softening inlet port 145, the gate groove communicating the softening inlet port 145 with the wastewater inner hole 146, the wastewater inner hole 146, and the wastewater passage 162; finally is discharged from the wastewater port 153.

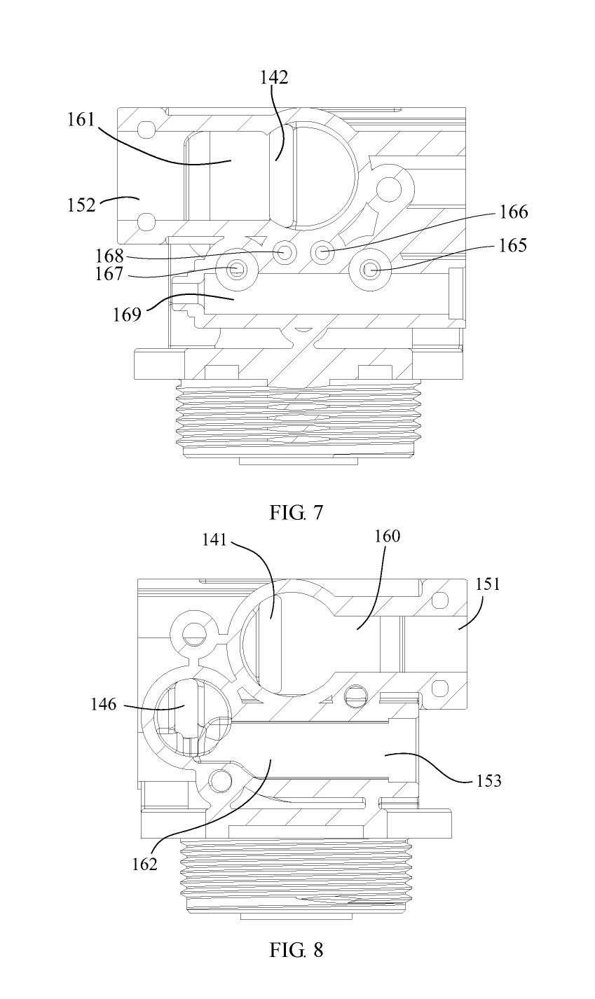

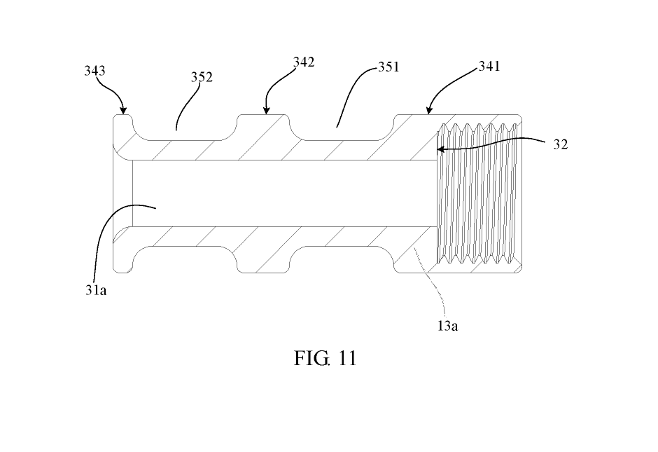

In some embodiments, referring to FIG. 4, FIG. 6 and FIG. 13, the plurality of gate grooves include a first gate groove 21, a fourth gate groove 24, as well as a second gate groove 22 and a third gate groove 23 located between the first gate groove 21 and the fourth gate groove 24.

The proximal cavity 12 is adjacent to the first gate groove 21, the distal cavity 13 is adjacent to the fourth gate groove 24,

the inner wall of the valve cavity 11 corresponding to the first gate groove 21 is provided with the wastewater inner hole 146;

the inner wall of the valve cavity 11 corresponding to the second gate groove 22 is provided with the forward washing jet flow hole 144 and the softening inlet port 145;

the inner wall of the valve cavity 11 corresponding to the third gate groove 23 is provided with the forward washing water-inlet port 143 and the water-inlet inner hole 141; and

the inner wall of the valve cavity 11 corresponding to the fourth gate groove 24 is provided with the backwashing water-inlet port 148 and the water-outlet inner hole 142.

Thereby, the forward washing jet flow hole 144 and the softening inlet port 145 share the first gate groove 21, the forward washing water-inlet port 143 and the water-inlet inner hole 141 share the third gate groove 23, the backwashing water-inlet port 148 and the water-outlet inner hole 142 share the fourth gate groove 24. Compared with the one-to-one arrangement of the gate groove and the “port” or the “hole”, the integration degree is higher, and the stroke of the piston body 31 to realize the waterway switching is shorter, so that the volume of the water softener valve 100 can be optionally reduced.

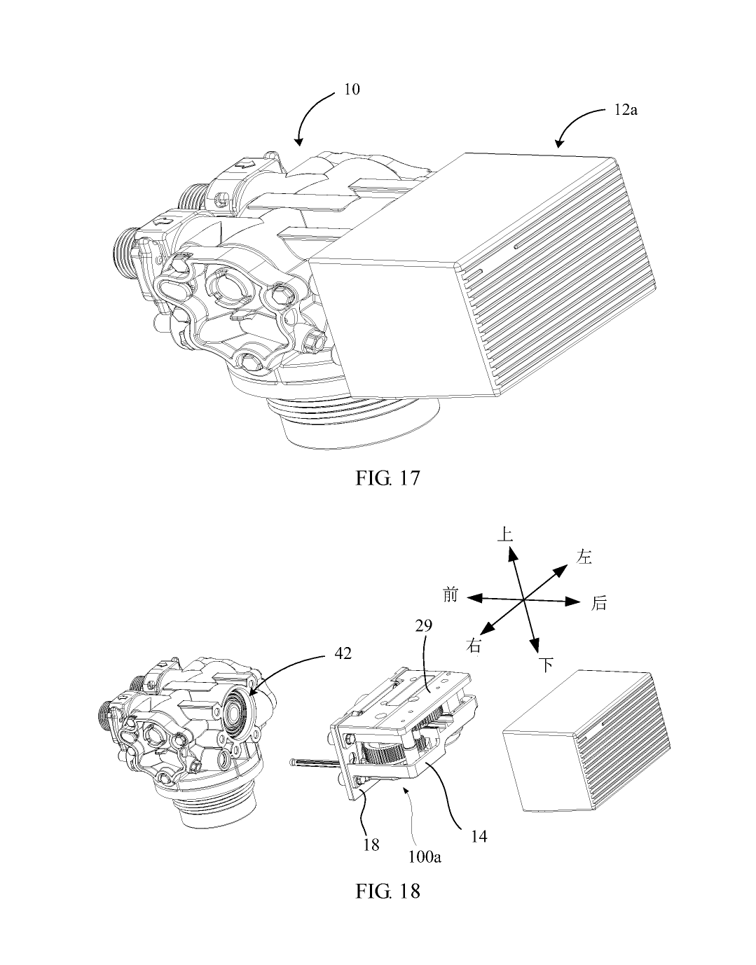

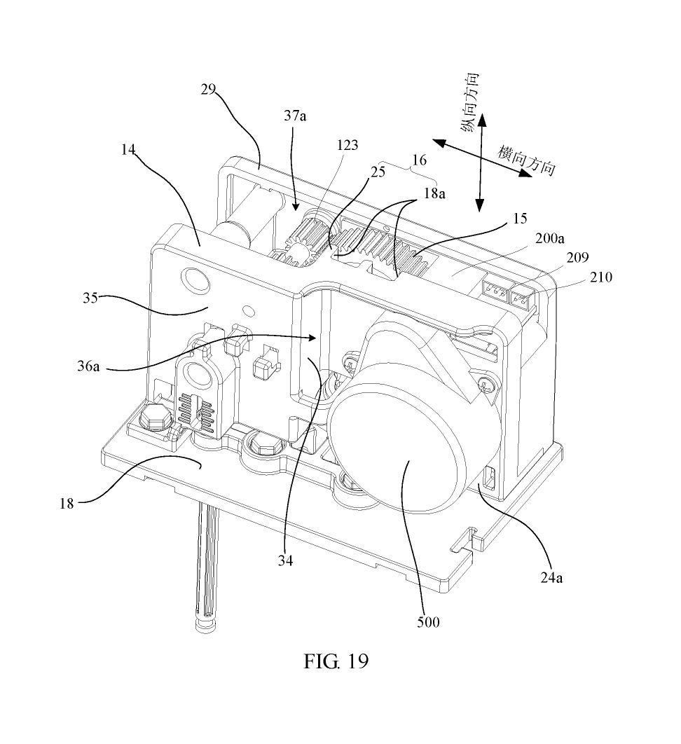

In some embodiments, referring to FIG. 10 and FIG. 11, the plurality of sealing surfaces include a first sealing surface 341, a second sealing surface 342 and a third sealing surface 343, the plurality of communicating grooves include a first communicating groove 351 and a second communicating groove 352.

The first sealing surface 341, the first communicating groove 351, the second sealing surface 342, the second communicating groove 352 and the third sealing surface 343 are sequentially arranged along the press-in direction; and the first gate groove 21, the second gate groove 22, the third gate groove 23 and the fourth gate groove 24 are sequentially arranged along the press-in direction.

In the present disclosure, as the piston body 31 is pressed in from the initial position, backwashing, water production, water injection, and forward washing are sequentially performed; and as the piston body 31 is pulled out from the deepest position, forward washing, water injection, water production and backwashing are sequentially performed. In addition, the backwashing water-inlet port 148 and the forward washing water-inlet port 143 are disposed adjacent to each other, convenient for both of them to communicate with the water-inlet inner hole 141, and convenient to block the corresponding forward washing water-inlet passage 166 and the backwashing water-inlet passage 168 to prevent water from collapsing. In the following, the cooperation relationship between the piston body 31 and the spacer group 2 in each working condition is described.

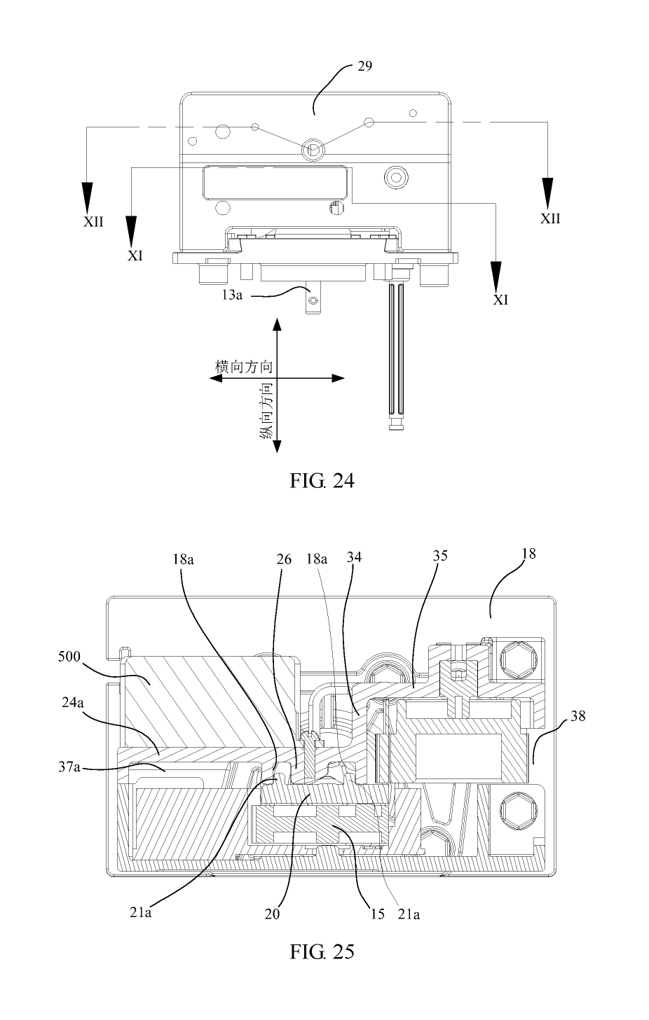

Referring to FIG. 15, when producing water, the first sealing surface 341 blocks the proximal cavity 12 from the first gate groove 21, the first communicating groove 351 communicates the second gate groove 22 with the third gate groove 23, the second sealing surface 342 blocks the third gate groove 23 from the fourth gate groove 24, and the second communicating groove 352 communicates the fourth gate groove 24 with the distal cavity 13; the salt suction passage is closed, and the water flow is indicated by arrows W1 and W4.

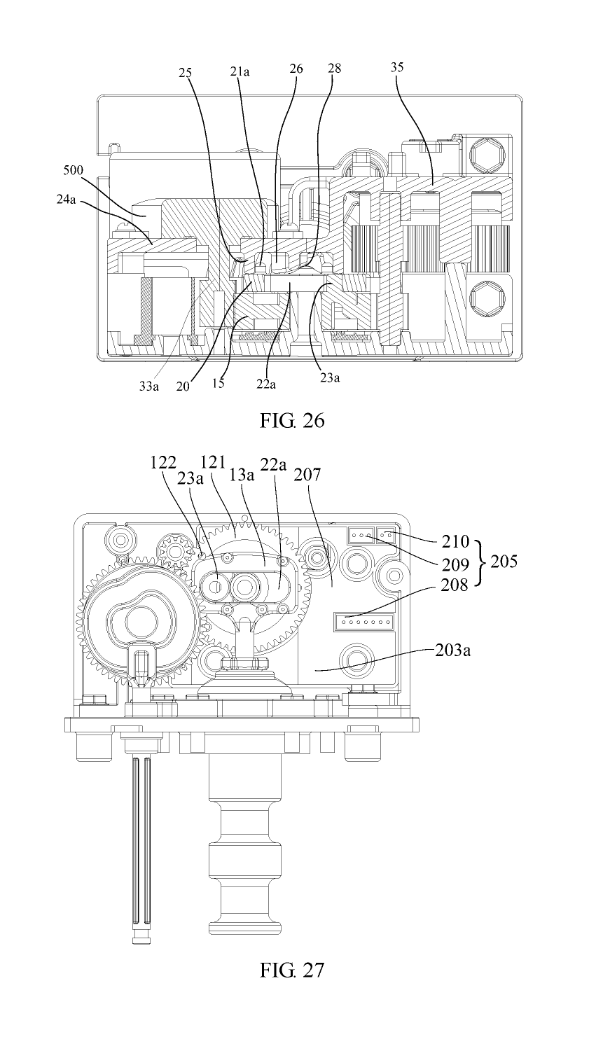

Referring to FIG. 16, when injecting water, the first sealing surface 341 blocks the proximal cavity 12 from the first gate groove 21, and blocks the first gate groove 21 from the second gate groove 22, the first communicating groove 351 communicates the second gate groove 22 with the third gate groove 23, the second sealing surface 342 blocks the third gate groove 23 from the fourth gate groove 24, the third communicating groove communicates the fourth gate groove 24 with the distal cavity 13; the water flow is indicated by arrows W5.

Referring to FIG. 13, when forward washing, the proximal cavity 12 communicates with the first gate groove 21, the first sealing surface 341 blocks the first gate groove 21 from the second gate groove 22, and blocks the second gate groove 22 from the third gate groove 23, the first communicating groove 351 communicates the third gate groove 23 with the fourth gate groove 24, the second sealing surface 342 blocks the fourth gate groove 24 from the distal cavity 13, the distal cavity 13 communicates with the water passage; the water flow is indicated by arrows W1, W2 and W3.

Referring to FIG. 14, when backwashing, the first sealing surface 341 blocks the proximal cavity 12 from the first gate groove 21; the first communicating groove 351 communicates the first gate groove 21 with the second gate groove 22, the second sealing surface 342 blocks the second gate groove 22 from the third gate groove 23, the second communicating groove 352 communicates the third gate groove 23 with the fourth gate groove 24, the third sealing surface 343 blocks the fourth gate groove 24 from the distal cavity 13; the water flow is indicated by arrows W1, W2 and W3.

In some embodiments, the first gate groove 21, the second gate groove 22, the third gate groove 23, and the fourth gate groove 24 are all annular, the first sealing surface 341, the first communicating groove 351, the second sealing surface 342, the second communicating groove 352 and the third sealing surface 343 are all annular, the first sealing surface 341, the second sealing surface 342 and the third sealing surface 343 are located in the same peripheral surface.

Each of the gate grooves is arranged in a ring shape, providing the water-inlet inner hole 141, the water-outlet inner hole 142, the forward washing water-inlet port 143, the forward washing jet flow hole 144, the softening inlet port 145, the wastewater inner hole 146, the backwashing water-inlet port 148, and the backwashing jet flow port 149 more selections for arrangements in the peripheral space. The adapted sealing surfaces and the communicating grooves are all arranged in ring shapes. And the sealing surfaces located in the same peripheral surface are advantageous for simplifying the structure of the piston body 31, as well as convenient for the piston body 31 to make a reciprocating movement.

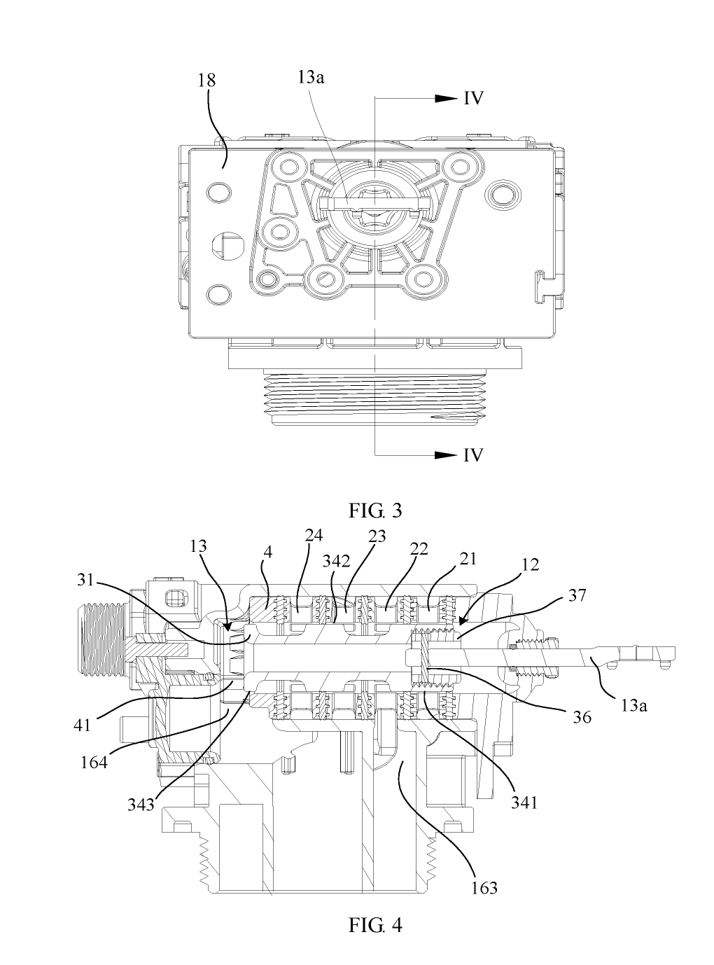

In some embodiments, referring to FIG. 1 and FIG. 2, the valve body 10 includes a main body 17 and a first end cap 18. The main body 17 is provided with an inner cavity having one end open, the first end cap 18 is covered with the opening of the valve body 10 and enclosed with the valve body 10 to form the valve cavity 11. The valve body 10 is arranged to be a split structure, facilitating for the assembly of the spacer group 2 and the piston assembly 3.

In some embodiments, referring to FIG. 4 and FIG. 13, the piston rod 13a extends out the valve body 10 through the first end cap 18, the proximal cavity 12 is adjacent to the first end cap 18, the valve cavity 11 is provided with a bottom surface opposite to the first end cap 18. The water softener valve 100 further includes an irregular grid 4 having a ring shape, the irregular grid 4 has a first recess 41 toward the bottom surface. The distal cavity 13 is formed between the first recess 41 and the bottom surface, the spacer group 2 is tightly pressed between the first end cap 18 and the irregular grid 4. Thus, the spacer group 2 is allowed to be firmly fixed inside the valve body 10, ensuring that the waterway is correctly switched as the piston body 31 moves relative to the spacer group 2.

In some embodiments, referring to FIG. 10 and FIG. 11, the piston body 31 is integrally arranged. The piston assembly 3 further includes a first connecting member 36 and a first fastening member 37, the first connecting member 36 is disposed on the piston rod 13a. The first connecting member 36 and the piston rod 13a are in a position-limiting cooperation in the telescopic direction of the piston rod 13a, the first fastening member 37 is cooperated with the piston body 31 to limit the first connecting member 36 in the telescopic direction. It should be understood that, the piston body 31 and the piston rod 13a are connected via the first connecting member 36 and the first fastening member 37, which facilitates the piston body 31 and the piston rod 13a to be machined into shape respectively.

In some embodiments, the piston body 31 is integrally injection molded, the piston body 31 is provided with a cavity 31 extending along the telescopic direction and having both ends through, the inner wall of the inner cavity is provided with a third stepped surface 32.

The outer peripheral surface of the piston rod 13a is provided with an via hole (not labeled), the first connecting member 36 has an elongated shape and is disposed through the via hole. The first fastening member 37 is annular and embedded in the cavity 31a. An annular space formed between the inner annular surface of the first fastening member 37 and the outer peripheral surface of the piston rod 13a communicates with the cavity 31a. The first connecting member 36 is clamped between the third stepped surface 32 and the first fastening member 37.

Since the piston body 31 is integrally injection molded, compared with the existing ceramic components that are separated and separable, the cost is lower and the assembly is easier. The first connecting member 36 partially blocks the annular space between the first fastening member 37 and the piston rod 13a, thereby ensuring the smooth flow of the water passage. The arrangement of the first fastening member 37 allows a detachable connection between the piston body 31 and the piston rod 13a. Specifically, the first connecting member 36 is a pin, and the first fastening member 37 is an inner angle lifting nut, so that the first fastening member 37 can be threadedly cooperated with the piston body 31.

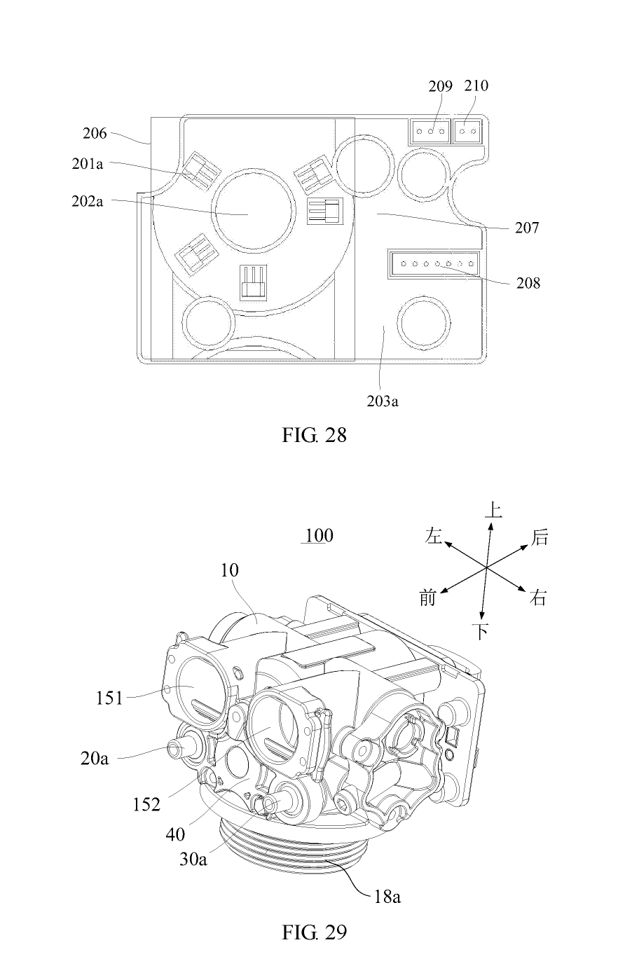

In one embodiment of the present disclosure, referring to FIG. 1 and FIG. 17-19, the water softener valve includes a valve body 10, a piston assembly 3 and a driving mechanism 12a, the piston assembly 3 includes a piston rod 13a, the driving mechanism 12a includes a mounting seat 14 and a cam 15. The piston rod 13a extends out of one end of the valve body 10 and is in a transmission cooperation with the cam 15. The mounting seat 14 is provided with a sliding connection structure 16, the end of the piston rod 13a extending out the valve body 10 is provided with a sliding cooperation portion 17a. The sliding cooperation portion 17a is slidably cooperated with the sliding connection structure 16 along the longitudinal direction, and the sliding cooperation portion 17a is in a position-limiting cooperation with the sliding connection structure 16 along the lateral direction. The longitudinal direction coincides with the length direction of the piston rod 13a, the lateral direction is perpendicular to the longitudinal direction and the axial direction of the cam 15.

In one embodiment, the cam 15 is in a transmission cooperation with one end of the piston rod 13a. For example, an eccentric annular groove is disposed on the cam 15, and a protrusion that is slidably cooperated with the annular groove is disposed on the piston rod 13a; or, an eccentric projection is provided on the cam 15, and a strip groove that is slidably cooperated with the projection is provided on the piston rod 13a. The end of the piston rod 13a extending into the valve body 10 connects to the main piston, the piston rod 13a linearly reciprocates to drive the main piston to stop at different working conditions, thereby realizing different waterway switching. Similar to the cooperation of the cam 15 and the piston rod 13a, the sliding connection structure 16 on the mounting seat 14 is a protrusion, and correspondingly, the sliding cooperation portion 17a is a groove mated with the protrusion; in contrast, if the sliding connection structure 16 is a groove, the sliding cooperation portion 17a is a protrusion mated with the groove.

It should be understood that, as the rotational movement of the cam 15 is converted into the linear movement of the piston rod 13a, in addition to the force that pulls the piston rod 13a out of the valve body 10 or presses the piston rod 13a into the valve body 10, a force that makes the piston rod 10a to swing in the lateral direction is also generated. In the existing structures, the swing force is directly transmitted to the sliding pair between the piston rod 13a and the valve body 10. However, in the present disclosure, this swing force can be counteracted by the cooperation of the sliding connection structure 16 with the sliding cooperation portion 17a in the lateral direction, so that the swing force transmitted to the cooperation portion of the piston rod 13a and the valve body 10 is greatly reduced.

In some embodiments, referring to FIG. 24-25, the sliding connection structure 16 includes two slideways 18a opposite to each other in the lateral direction. The sliding cooperation portion 17a extends between the two slideways 18a and slidably cooperated with the two slideways 18 along the longitudinal direction. Because the sliding cooperation portion 17a extends between the two slideways 18a and moves relative to the valve body 10, the dimensions of the sliding cooperation portion 17a in the longitudinal direction may be as small as possible. Therefore, under the premise that the same stroke is realized in the longitudinal direction, compared with the arrangement that the sliding cooperation portion 17a disposed on the piston rod 13a is a groove while the sliding connection structure 16 is a corresponding protrusion, the movement space required by the piston rod 13a is smaller and the structure thereof is more compact.

In the water softener valve of the present disclosure, the sliding connection structure 16 is disposed on the mounting seat 14, and the sliding connection portion 17a is disposed on the piston rod 13a to cooperated with the sliding connection structure 16, so as to form plural guiding structures, combined with the position-limiting cooperation between the sliding cooperation portion 17a and the sliding connection structure 16, therefore, as the rotational movement of the cam 15 is converted into the linear movement of the piston rod 13a, the sliding connection structure 16 can restrict the piston rod 13a from swinging in the lateral direction, and share the compressive stress of the piston rod 13a acting on the valve body 10 in the lateral direction. On the one hand, the risk of wear and looseness of the sliding substructure between the piston rod 13a and the valve body 10 can be reduced, and on the other hand, the movement of the piston rod 13a can be made more stable.

In some embodiments, referring to FIG. 1, 2, 20-22, the piston rod 13a includes a rod portion 19 and a transmission cooperation portion 20 disposed at one end of the rod portion 19. The transmission cooperation portion 20 is located outside the valve body 10. The sliding cooperation portion 17a includes a plurality of sliding shafts 21a disposed on the side of the transmission cooperation portion 20 facing away from the cam 15, and the plurality of sliding shafts 21a are arranged in two rows respectively slidably cooperated with the two slideways 18a along the longitudinal direction.

The plurality of sliding shafts 21a of the sliding cooperation portion 17a are distributed, and the contact formed by the outer peripheral surface of the sliding shaft 21a and the slideway 18a is a line contact. Due to the small contact area, on one hand, it is easier to ensure the assembly accuracy of the slide shafts 21a and the slideways 18a during manufacture, to avoid interference due to manufacturing precision errors, and on the other hand, the frictional force generated when moving along the longitudinal direction is also smaller.

In some embodiments, referring to FIG. 25 and FIG. 26, the transmission cooperation portion 20 respectively protrudes from the peripheral surface of the rod portion 19 in the lateral direction, the transmission cooperation portion 20 is provided with a sliding groove 22a extending along the longitudinal direction, the cam 15 is provided with an eccentric shaft 23a adapted to the sliding groove 22a, and the plurality of sliding shafts 21a are disposed at the periphery of the sliding groove 22a.

Similarly, the stroke of the piston rod 13a along the longitudinal direction is mainly determined by the eccentricity degree of the eccentric shaft 23a. And with respect to the member of the valve body 10 moves along the longitudinal direction, the sliding groove 22a on the piston rod 13a extends along the lateral direction. Therefore, on the premise that the same stroke is achieved in the longitudinal direction, compared with that the sliding groove 22a is obliquely disposed relative to the lateral direction, the piston rod 13a requires less movement space and is more compact.

In some embodiments, each of the two rows of sliding shafts is disposed on the side of the sliding groove 22a facing away from the valve body 10. The axis of the sliding shaft 21a that the sliding shaft 21a presses one of the slideways when the eccentric shaft 23a presses the groove wall of the sliding groove 22a facing away from the valve body 10, is further away from the valve body 10 in the longitudinal direction than the axis of the sliding shaft 21a that the sliding shaft 21a presses the other of the slideways when the eccentric shaft 23a presses the groove wall of the sliding groove 22a facing close to the valve body 10.

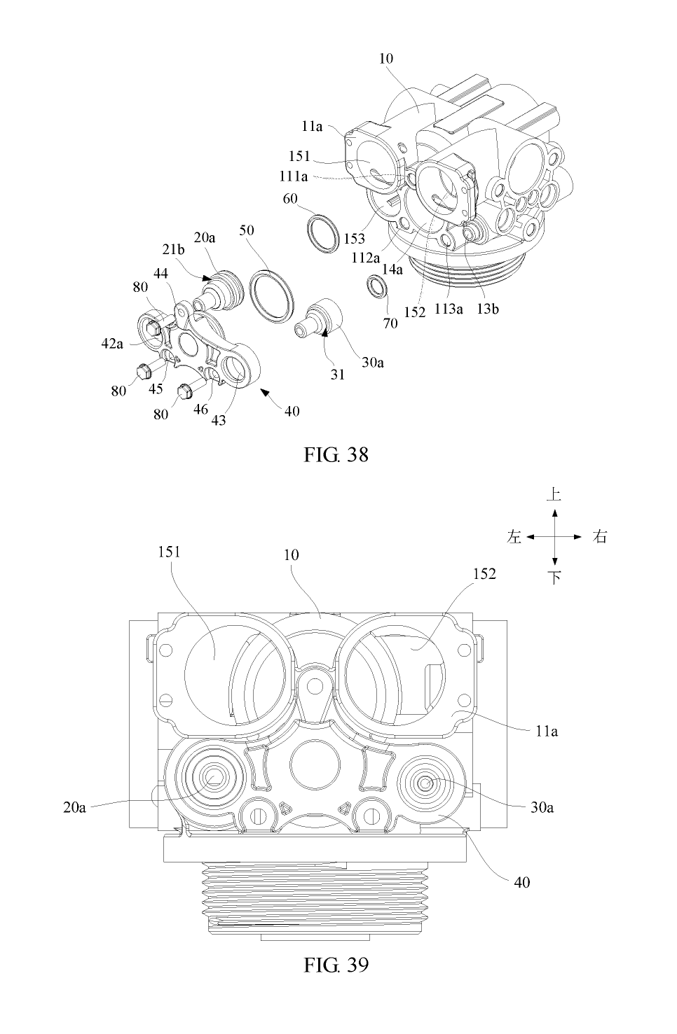

Taking the orientation shown in FIG. 22 as an example, a space H is formed between the two sliding shafts 21a on the upper side of the sliding groove 22a in the longitudinal direction, and the left sliding shaft 21a is higher than the right slide shaft 21a. It should be understood that, in the process that the eccentric shaft 23a pulls the piston rod 13a out of the valve body 10, the eccentric shaft 23a presses the groove wall of the sliding groove 22a away from the valve body 10, and the frictional force generated thereby is transmitted via the two sliding shafts 21a on the left side to the left side of the slideway, not shown in FIG. 22. The reaction force of the left slideway acting on the sliding shaft 21a in the upper left corner is relatively larger than the force arm of the upper groove wall of the sliding groove 22a, so that the reaction required to achieve the balance friction is relatively small. Thereby, the friction force between the sliding shaft 21a disposed at the left upper corner and the left slideway can be reduced, and the transmission cooperation portion 20 is less likely to swing in the lateral direction. In the process that the eccentric shaft 23a presses the piston rod 13a into the valve body 10, the reaction force of the right slideway acting on the sliding shaft 21a in the upper right corner is relatively larger than the force arm of the lower groove wall of the sliding groove 22a, which is also possible to reduce the swing of the transmission cooperation portion 20 along the lateral direction.

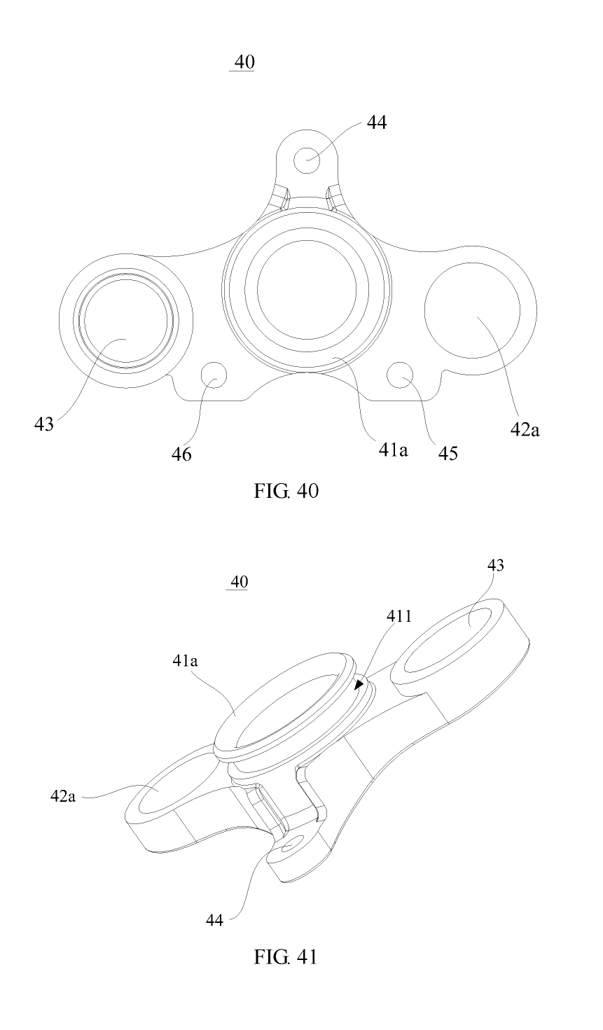

In some embodiments, referring to FIG. 23, FIG. 25 and FIG. 26, the mounting seat 14 includes a first mounting plate 24a, the sliding connection structure 16 includes two parallel ribs 25 disposed on the side of the first mounting 24a facing the piston rod 13a. The ribs 25 extend along the longitudinal direction, and the two slideways 18a are formed on the side of the two ribs 25 facing with each other. In some embodiments of the present disclosure, the two slideways 18a of the sliding structure 16 are formed by arranging the ribs 25 on the plate-like structure, namely the first mounting plate 24a, compared with the ways that the slideways are formed by removing materials from a thicker plate-like structure or a block structure the materials directly, which ensures the strength of the structure, and reduces the weight of the corresponding structure.

In some embodiments, referring to FIG. 1, 2, 20-26, the side of the rod portion 19 facing the cam 15 is flush with the side of the transmission cooperation portion 20 facing the cam 15. The transmission cooperation portion 20 is in a gap cooperation with the side facing the cam 15. The side the rod portion 19 facing away from the cam 15 protrudes from the side of the transmission cooperation portion 20 facing away from the cam 15. The side of the first mounting plate 24a facing the cam 15 is provided with a fixing post 26 between the two ribs 25. A fixing hole 27 penetrating through the first mounting plate 24a is disposed in the fixing post 26, and the end of the fixing post 26 close to the transmission cooperation portion 20 is provided with a notch 28 for avoiding the rod portion 19.

It should be understood that, by adjusting the relative positional relationship between the rod portion 19 of the piston rod 13a and the transmission cooperation portion 20, the cooperation between the transmission cooperation portion 20 and the cam 15 is more compact. The cam 15 can also limit the piston rod 13a in the axial direction of the cam 15 to a certain extent, preventing the transmission cooperation portion 20 from excessively swinging in the axial direction of the cam 15. The fixing post 26 also extends between the two slideways 18a, while avoiding interference with the piston rod 13a by providing the notch 28, makes full use of the space between the two slideways 18a. The fixing hole 27 is disposed in the fixing post 26 to ensure the connection strength, and the fixing hole 27 is configured to fix the components of the side that the first mounting plate 24a faces away from the side of the cam 15. Specifically, the fixing hole 27 may be configured to mount a power device 500 of the following embodiments. In some embodiments, the power device 500 is a speed reducer group.

In some embodiments, the driving mechanism 12a further includes a covering plate 29 which covers the mounting seat 14. The cam 15 and the piston rod 13a are located between the covering plate 29 and the mounting seat 14. The outer peripheral surface of the cam 15 is provided with gear rings 30. The driving mechanism 12a further includes a power device 500 disposed on the side of the first mounting plate 24a facing away from the covering plate 29. The first mounting plate 24a is provided with an via hole 32a, an output shaft of the power device 500 passes through the via hole 32a and cooperates with the gear rings 30 on the outer circumference of the cam 15.

It should be understood that, by setting the covering plate 29, a better protection for the mounting seat 14 is provided, to prevent foreign matter from falling and affecting the normal operation of the transmission. And by setting the speed reducer group, a larger initial torque can be output, and the cooperation of the output shaft 33a with the gear rings 30 on the outer peripheral surface of the cam 15 is advantageous for ensuring the accuracy of the transmission.

In some embodiments, the mounting seat 14 further includes a first connecting plate 34 and a second mounting plate 35. The first connecting plate 34 extends from one side of the first mounting plate 24a and away from the cam 15; the second mounting plate 35 extends from the edge of the first connecting plate 34 away from the cam 15 along the lateral direction, and away from the first connecting plate 34. The first mounting plate 24a and the first connecting plate 34 are enclosed to form a mounting recess 36a for the power device 500 to be mounted. A first mounting cavity 37a is formed between the first mounting plate 24a and the cover plate 29, a second mounting cavity 38 is formed between the first connecting plate 34, the second mounting plate 35 and the covering plate 29. The cam 15 is located in the first mounting cavity 37a.

It should be understood that, by providing the first connecting plate 34 and the second mounting plate 35, a more layered mounting space is formed after the mounting seat 14 is cooperated with the covering plate 29. For example, the mounting recess 36a is located outside the mounting seat 14, to facilitate the disassembly or maintenance of the power device 500. And corresponding to the mounting recess 36a, the second mounting cavity 38 is wider than the first mounting cavity 37a in the axial direction of the cam 15, and the space of the mounting recess 36a on the side in the lateral direction is utilized, making the structure of the water softener valve more compact.

In some embodiments, the driving mechanism 12a further includes a gear set (not labeled) for driving the salt suction water injection valve (not labeled). The input wheel of the gear set engages with the cam 15, and the gear set is located in the second mounting cavity 38. The input wheel of the gear set engages with the cam 15, which allows the salt suction water injection valve to share the power source with the piston assembly 3. The gear set generally has a double layer structure, and is more suitable for the second mounting cavity 38 which is wider in the axial direction of the cam 15, making full use of the space.

In some embodiments, referring to FIG. 2 and FIG. 18, the valve body 10 includes a main body 17 and a first end cap 18. The main body 17 is provided with a valve cavity 11 having one end open, the first end cap 18 is covered with the opening 42 of the valve cavity 11. The first end cap 18 is provided with a mounting hole (not labeled) for the piston rod 13a to extend out the valve body 10. The mounting seat 14 and the covering plate 29 are fixed on the first end cap 18. The first end cap 18 is separately arranged, which allows the first end cap 18 to be assembled to the body 17 after being assembled with the driving structure, which is more convenient for assembly. Generally, the mounting seat 14 and the covering plate 29 are mounted to the first end cap 18 by bolt or screw, and the first end cap 18 may also be mounted to the main body 17 by screw. In addition, the mounting seat 14 and the covering plate 29 may also be fixed to the first end cap 18 by welding, for example, by ultrasonic welding between plastic members, or electric welding between the metal members.

In one embodiment of the present disclosure, referring to FIG. 18-20, the water softener valve includes a control box 100a. The control box 100a includes a housing assembly 110 and a transmission mechanism 120, the housing assembly 110 is configured to connect to the valve body 10 of the water softener valve, the transmission mechanism 120 is configured to connect to the piston rod 13a, to drive the piston rod 13a to move. The valve body 10 of the water softener valve has a plurality of passages, the piston rod 13a is movably connected to the valve body 10, and moves relative to the valve body 10, to control the opening and closing of the plurality of passages, so to allow the water softener valve in different working conditions. Specifically, the valve body 11 is provided with a water-inlet passage, a forward washing passage, a backwashing passage, a jet flow passage, a slat suction passage, a softening-inlet passage, a softening-outlet passage, a wastewater passage and so on. The transmission mechanism 120 controls the movement of the piston rod 13a, to control the opening or closing of different passages, so as to allow the water softener valve 100 in different conditions, such as working, water injection, salt suction, forward washing, backwashing. The piston rod 13a may be slidably connected to the valve body 10, or rotatably connected to the valve body 10, which depends on the structure of the water softener valve.

As the water softener valve 100 is in different working positions, the piston rod 13a and the transmission mechanism 120 are in different positions too. In order to accurately detect the operating state of the water softener valve 100, a detecting device is usually provided in the control box 100a, to detect the position of the piston rod 13a or the transmission mechanism 120, so as to determine the working status of the water softener valve 100.

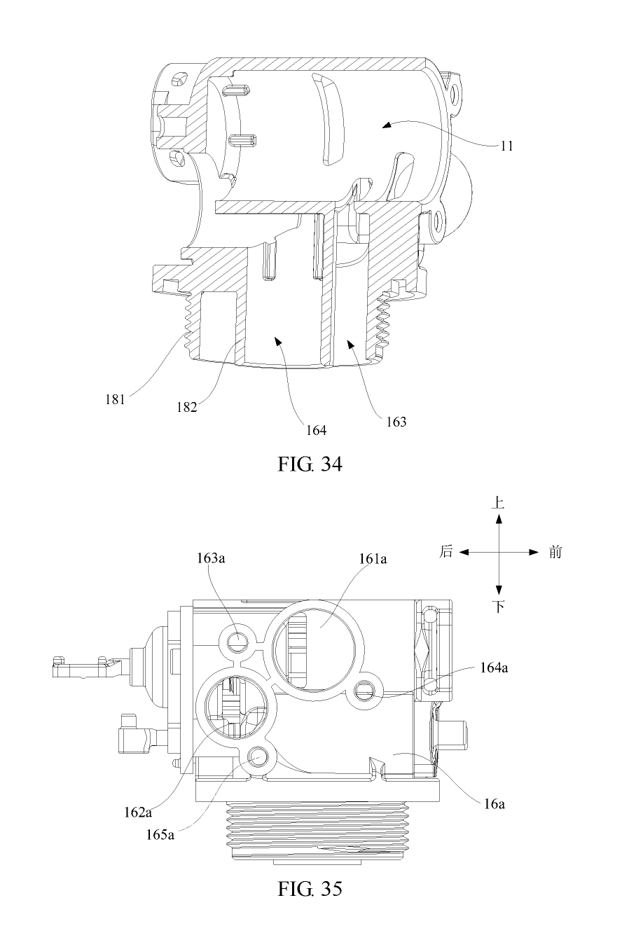

In one embodiment, as shown in FIG. 20 and FIG. 27, the transmission mechanism 120 includes a driving member 121 movably mounted in the housing assembly 110. The driving member 121 is configured to connect to the piston rod 13a of the water softener valve, to drive the piston rod 13a to move. An inductive structure 122 is disposed on the driving member 121, and an inductor 201a is disposed in the control box 100a The inductor 210a is configured to sense the inductive structure 122. The inductor 201a is disposed at a preset position of the electronic control board 200a, when the inductor 201a moves into the inductive area of the inductor 201a along with the piston rod 13a, the inductor 201a senses the inductive structure 122, and outputs corresponding electronic signal to the electronic control board 200a, so that the working status of the water softener valve is determined. The number of the inductors 201a may be plural, and the plurality of inductors 201a are set according to the positions of the driving member 121 at different working conditions, in order to accurately detect the working condition where the water softener valve is located. In addition, the driving member 121 may be directly connected to the piston rod 13a, or indirectly connected to the piston rod 13a via a connecting member, which is not to be detailed herein.

In some embodiments, as shown in FIG. 20 and FIG. 28, the electronic control board 200a may be mounted in the housing assembly 110, and the plurality of inductors 201a disposed on the electronic control board 200a, therefore, during the assembly process of the water softener valve, the step of connecting the inductors 201a to the electronic control board 200a is omitted, so that the assembly efficiency of the water softener valve is improved. In addition, since the plurality of inductors 201a are integrated on the electronic control board 200a, after the electronic control board 200a is mounted in the housing assembly 110, not only can the housing assembly 110 protect the electronic control board 200a, but also the structure of the water softener valve can be made more compact, so as to reduce the volume of the water softener valve.

In some embodiments, there are various types of the inductive structure 122 and the inductors 201a. For example, the inductor 201a is a distance inductor, and the inductive structure 122 is part of the driving member 121. The inductor 201a detects the position of the driving member 121 by detecting its distance from the inductive structure 122. Alternatively, the inductive structure 122 is a magnetic member connected to the driving member 121, and the inductor 201a includes a Hall element. When the magnetic member is close to the Hall element, the Hall element generates an electrical signal. Alternatively, the inductor 201a is a photoelectric inductor, and a detecting portion for detecting by the photoelectric inductor is provided on the driving member 121.

In one embodiment, the specific number of the inductors 201a may be determined according to the number of working conditions of the water softener valve. For example, if the water softener valve has working conditions including working, water injection, salt suction, forward washing, and backwashing, the number of the inductors 201a may be five, to correspond to the five different working conditions.

In some embodiments, as shown in FIG. 20 and FIG. 27, the driving member 121 is rotatably connected to the housing assembly 110, so as for the driving member 121 to rotate and drive the piston rod 13a to move, which reduces the movement space required for the driving member 121, and is advantageous for reducing the volume of the water softener valve. A plurality of inductors 201a may be distributed around the rotation axis of the drive member 121, to facilitate the detection of the inductive structure 122 on the driving member 121 by the inductor 201a.

It should be noted that, there are various ways for the driving member 121 to drive the piston rod 13a to move by rotation. For example, the driving member 121 is a gear structure, the piston rod 13a has a rack structure, and the gear structure engages with the rack structure, to drive the piston rod 13a to move; or, the piston rod 13a also has a gear structure, and the gear structure on the driving member 121 engages with the rack structure on the piston rod 13a, to drive the piston rod 13a to rotate. As shown in FIG. 20 and FIG. 27, the driving member 121 may also include a cam structure that connects to the piston rod 13a, to drive the piston rod 13a to move.

In one embodiment, as shown in FIG. 20, the driving member 121 includes a cam 15. The outer peripheral surface of the cam 15 is provided with gear rings 30, and the cam 15 connects to the piston rod 13a. The gear rings 30 are configured to receive a rotation force from a power device 500 of the water softener valve, and drive the cam 15 to rotate, further driving the piston rod 13a to move, so that the piston rod 13a is in different positions, thereby allowing the water softener valve to be in different working status. The electronic control board 200a is located on the side of the gear rings 30 facing away from the cam 15, the inductive structure 122 is disposed on the gear rings 30, and the inductor 201a is disposed on the side of the electronic control board 200a facing the cam 15, so as to allow the inductor 201a closer to the inductive structure 122, thereby improving the detection accuracy. There are various ways for the cam 15 to be connected to the piston rod 13a, which may be determined according to the specific structure of the piston rod 13a. For example, as shown in FIG. 27, the side of the piston rod 13a close to the driving member 121 is provided with a sliding groove 401, and the cam 15 is provided with an eccentric shaft 23a extending in the sliding groove 401. When the cam 15 rotates, the eccentric shaft 23a slides in the sliding groove 401, and pushes the piston rod 13a to move.

In some embodiments, when the driving member 121 includes the gear rings 30 and the cam 15, as shown in FIG. 20, the power device 500 includes a motor, the transmission mechanism 120 further includes a transmission gear 123. The transmission gear 123 is configured to connect to the rotation shaft of the motor, and the transmission gear 123 engages with the gear rings 30 of the driving member 121, to allow the driving member 121 to receive the driving force from the motor. The transmission ratio of the transmission gear 123 to the gear rings 30 may be larger than 1, to increase the driving ability of the driving member 121. Alternatively, the motor is the speed reducer group as mentioned above, to increase the driving ability of the motor.

It should be noted that, the number of the transmission gear 123 may be one or plural, which depends on the structure of the transmission mechanism 120. In addition, the driving member 121 may be directly connected to the power device 500, which is not to be detailed herein.

Of course, the driving member 121 may slide relative to the housing assembly 110, to drive the piston rod 13a to move. For example, the driving member 121 is a cylinder, a hydraulic cylinder, and so on, which is not be detailed herein.

In one embodiment, the electronic control board 200a is opposite to the transmission mechanism 120, and the receiving dent 204 is opened on the side of the electronic control board 200a facing the transmission mechanism 120, to allow at least part of the transmission mechanism 120 to be located in the receiving dent 204, which contributes to the compact structure of the electronic control board 200a and the transmission mechanism 120, further reducing the volume of the control box 100a.

In one embodiment, a part of the transmission member 121 of the transmission mechanism 120 is received in the receiving dent 204, to reduce the distance between the electronic control board 200a and the transmission member 121, thereby reducing the distance between the inductor 201a on the electronic control board 200a and the inductive structure 122 on the transmission member 121, so as to improve the detection accuracy of the sensor 201a.

In one embodiment, a positioning structure is provided in the housing assembly 110, to positioning the electronic control board 200a, which facilitates the installation of the electronic control board 200a. Specifically, as shown in FIG. 20 and FIG. 28, a positioning post 111 is provided in the housing assembly 110, and a positioning hole 202a is opened at the position of the electronic control board 200a corresponding to the positioning post 111. When the electronic control board 200a is mounted into the housing assembly 110, the positioning post 111 is inserted into the positioning hole 202a, to restrict the movement of the electronic control board 200a along the radial direction of the positioning post 111. The positioning hole 202a may be a through hole, or a blind hole, which is determined according to the structure of the positioning post 111. For example, when the driving member 121 is rotatably connected to the housing assembly 110, the positioning post 111 is passed through the electronic control board 200a, to support the driving member 121, for this case, the positioning hole 202a is a blind hole. Of course, a shorter positioning post 111 may be protruded on the inner wall of the housing assembly 110, and correspondingly, the positioning hole 202a is a blind hole. When the electronic control board 200a is mounted in the housing assembly 110, the positioning post 111 is inserted into the blind hole, to position the electronic control board 200a.

In some embodiments, the cross-sectional shape of the positioning post 111 is the same with that of the positioning hole 202a, to avoid a gap between the positioning post 111 and the inner wall of the positioning hole 202a, and shakes of the electronic control board 200a caused by the gap, thereby avoiding impact on the detection accuracy of the inductors 201a disposed on the electronic control board 200a.

The number of the positioning post 111 may be plural, to improve the positioning effect of the positioning post 111 on the electronic control board 200a, and prevent the electronic control board 200a from rotating with the central line of the positioning post 111 as the rotation axis. Or, the cross-section of the positioning post 111 is a non-circular cross-section, and the shape of the positioning hole 202a is the same with the cross-section of the positioning post 111, so as to prevent the electronic control board 200a from rotating.

In one embodiment, as shown in FIG. 19 and FIG. 27, the housing assembly 110 includes a covering plate 29 and a mounting seat 14, the covering plate 29 and the mounting seat 14 extend along the length direction of the positioning post 111. The transmission mechanism 120 and the electronic control board 200a are located between the covering plate 29 and the mounting seat 14. The electronic control board 200a may be provided with a positioning portion 203a, the thickness of the positioning portion 203a in the length direction of the positioning post 111 is equivalent to the distance between the covering plate 29 and the mounting seat 14. Thus, when the electronic control board 200a is mounted in the space formed by the covering plate 29 and the mounting seat 14, the covering plate 29 and the mounting seat 14 can restrict the movement of the electronic control board 200a along the length direction of the positioning post 111.

It should be noted that, the covering plate 29 and the mounting seat 14 may be directly connected, or indirectly connected by other structures. And the shape of the positioning portion 203a may be determined according to the space between the covering plate 29 and the mounting seat 14, which is not limited herein.

In some embodiments, as shown in FIG. 19, the control box 100a is provided with a first end cap 18 connected to the valve body 10. The covering plate 29 and the mounting seat 14 are respectively connected to the first end cap 18, and the covering plate 29 and the mounting seat 14 are connected to each other, so as to make the structure of the control box 100a more stable.

In some embodiments, as shown in FIG. 20, one side of the covering plate 29 facing the electronic control board 200a is provided with a mounting dent 114. The electronic control board 200a is mounted in the mounting dent 114, and the shape of the electronic control board 200a is adapted to the shape of the mounting dent 114, to allow the inner peripheral wall of the mounting dent 114 to limit the electronic control board 200a.

It should be noted that, the positioning may be performed by any one or more of the three positioning manners, the three positioning manners including the positioning post 111, the positioning portion 203a and the mounting dent 114. Of course, when the electronic control board 200a is positioned by the above three positioning ways at the same time, the positioning effect is better, and the step of setting screws is saved, which is convenient for the installation, as well as conducive to improving the assembly efficiency of the water softener valve.

In some embodiments, as shown in FIG. 20 and FIG. 28, an external connector 205 is further provided on the electronic control board 200a, the external connector 205 is configured to connect to other electronic component, in order to detect or control signal. The side of the electronic control board 200a facing the transmission mechanism 120 is provided with an avoiding area 206. The avoiding area 206 and the transmission mechanism 120 are facing each other, the external connector 205 on the electronic control board 200a is disposed outside the avoiding area 206, to prevent the wire connected to the external connector 205 from being in contact with the transmission mechanism 120 and caught in the transmission mechanism 120.

In some embodiments, the external connector 205 includes a main control board connector 208. The main control board connector 208 is configured to be electrically connected to a main control board (not shown) of the water softener, to transmit working condition signal, flow signal and the like to the main control board.

In some embodiments, the external connector 205 further includes a motor connector 209, the motor connector 209 is configured to be electrically connected to a motor of the water softener valve, to control the motor to rotate or stop. In one embodiment, the external connector 205 further includes a flow inductor connector 210, the flow inductor connector 210 is configured to be connected to a flow inductor (not shown) of the water softener, to receive flow signal fed back by the flow inductor. It should be noted that, the external connector 205 may include one of the motor connector 209 and the flow inductor connector 210, and may also include both the motor connector 209 and the flow inductor connector 210.

In some embodiments, as shown in FIG. 20 and FIG. 28, the housing assembly 110 is further provided with an isolation portion 207 therein. The isolation portion 207 is located on the side of the electronic control board 200a facing the transmission mechanism 120, and between the transmission mechanism 120 and the external connector 205, to isolate the transmission mechanism 120 and the external connector 205, further preventing the wire from being caught in the transmission mechanism 120. The isolation portion 207 may be connected to the inner wall of the housing assembly 110, or connected to the electronic control board 200a, or connected to both the electronic control board 200a and the inner wall of the housing assembly 110.

In some embodiments, the isolation portion 207 and the electronic control board 200a are integrally arranged, and the thickness of the isolation portion 207 in the length direction of the positioning post 111, is equivalent to the distance between the covering plate 29 and the mounting seat 14, thus, the isolation portion 207 may be used as the positioning portion 203a, to simplify the structure of the electronic control panel 200a. Of course, the side of the electronic control board 200a facing the transmission mechanism 120 may be provided with an electronic component to form the isolation portion 207, which is not be detailed herein.

In one embodiment of the present disclosure, as shown in FIG. 29-37, the water softener valve 100 includes a valve body 10, the valve body 10 includes a valve cavity 11 as well as a water-inlet passage 160, a water-outlet passage 161, a softening-inlet passage 163, a softening-outlet passage 164, a wastewater passage 162 and a salt suction passage. The valve cavity 11, the water-inlet passage 160 and the wastewater passage 162 all extend along the first direction. The valve body 10 is provided with a first end surface 16a in the second direction, the water-inlet passage 160 and the wastewater passage 162 are both arranged adjacent to the first end surface 16a. The first end surface 16a is provided with a first flow guiding hole 161a communicating with the water-inlet passage 160, and a second flow guiding hole 162a communicating with the wastewater passage 162. The first direction is perpendicular to the second direction. The water softener valve 100 further includes a second end cap 20b configured to cover the first flow guiding hole 161a and the second flow guiding hole 162a.

The water softener valve 100 is applied to a water softener, to realize working conditions such as softening treatment, salt suction water washing and water injection. The water-inlet passage 160 is configured to introduce raw water into the valve cavity 11, the water-outlet passage 161 is configured to drain the softened water from the valve cavity 11. The softening-inlet passage 163 is configured to, during the softening condition, introduce raw water into the ion exchange tank 200 of the water softener, the softening-outlet passage 164 is configured to output the softened water after being softened. The salt suction passage is configured to inhale salt water from the salt box 300 of the water softener, or to inject water into the salt water box 300 of the water softener. The wastewater passage 162 communicates with the valve cavity 11, being configured to drain the wastewater generated after the salt suction forward washing or the salt suction backwashing.

The valve cavity 11, the water-inlet passage 160 and the wastewater passage 162 all extend along the first direction, the valve body 10 has a first end surface 16a in the second direction, and the first direction is perpendicular to the second direction. In some embodiments, the first direction is consistent with the front-rear direction, the third direction is consistent with the right-left direction. The first end surface 16a may be any end surface of the valve body 10 in the second direction (as shown in FIG. 30, the left end surface is taken as an example). Specifically, referring to FIG. 32 and FIG. 33, the water-inlet passage 160 and the wastewater passage 162 are both disposed adjacent to the first end surface 16a, the valve body 11 is located on the side of the water-inlet passage 160 away from the first end surface 16a. The first flow guiding hole 161a extends from the first end surface 16a along the second direction, and communicates with the water-inlet passage 160, the wall of the water-inlet passage 160 opposite to the first flow guiding hole 161a is provided with a first communicating hole 121a communicating with the valve cavity 11. The second flow guiding hole 162a extends from the first end surface 16a along the second direction, and communicates with the wastewater passage 162, the wall of the wastewater passage 162 opposite to the second flow guiding hole 162a is provided with a second communicating hole 151a communicating with the valve cavity 11. The second end cap 20b covers the first flow guiding hole 161a and the second flow guiding hole 162a to seal the water. The second end cap 20b and the valve body 10 may be fixed by welding, snapping or screwing.

By providing the first flow guiding hole 161a, the first communicating hole 121a can be formed by the drafting process in the injection molding, by providing the second flow guiding hole 162a, the second communicating hole 151a can be formed by the drafting process in the injection molding, and the second end cap 20b can seal the first flow guiding hole 161a and the second flow guiding hole 162a simultaneously. Therefore, the water in the water-inlet passage 160 can be conveyed into the valve cavity 11 under the guidance of the first flow guiding hole 161a, and the wastewater discharged from the valve cavity 11 can enter the wastewater passage 162 under the guidance of the second flow guiding hole 162a to be discharged, making the pipelines inside the valve body 10 is neatly, and the waterway smooth.

In the water softener valve 100 of the present disclosure, the layout of the pipelines inside valve body 10 and the external connectors is optimized, the valve body 10, the wastewater passage 162 and water-inlet passage all extend along the first direction, the first end surface 16a is provided with both the first flow guiding hole 161a and the second flow guiding hole 162a. The first flow guiding hole 161a communicates with the water-inlet passage 160 to guide the raw water entering from the water-inlet passage 160 to the valve cavity 11, the second flow guiding hole 162a communicates with the wastewater passage 162 to guide the wastewater from the valve cavity 11 to the wastewater passage 162, which makes the arrangement of internal pipeline structure and external ports of the water softener valve 100 more regular, and the structure more compact. The first flow guiding hole 161a and the second flow guiding hole 162a are disposed on the same end surface of the valve body 10. Therefore, by setting the second end cap 20b, the first flow guiding hole 161a and the second flow guiding hole 162a can be simultaneously sealed, simplifying the types of components, which is advantageous for simplifying the overall structure of the water softener valve 100. Thereby, the water softener valve 100 has a regular and compact structure, convenient for reducing the overall size of the water softener valve 100, and when applied to a water softener, the whole size can be effectively reduced.

In some embodiments, referring to FIG. 36, the side of the second end cap 20b cooperated with the first end surface 16a, corresponding to the first flow guiding hole 161a and the second flow guiding hole 162a, is respectively provided with a first flange 21c and a second flange 22b. The first flange 21c is sealingly cooperated with the inner wall of the first flow guiding hole 161a, the second flange 22b is sealingly cooperated with the inner wall of the second flow guiding hole 162a.

In some embodiments, the first flange 21c and the second flange 22b are disposed on the second end cap 20b. During assembly, the first flange 21c is inserted into the first flow guiding hole 161a, the second flange 22b is inserted into the second flow guiding hole 162a, to allow the second end cap 20b and the first end surface 16a are in a tight cooperation, simplifying the assembly process. The first flange 21c is sealing cooperated with the inner wall of the first flow guiding hole 161a, the second flange 22b is sealing cooperated with the inner wall of the second flow guiding hole 162a, to ensure a better sealability between the second end cap 20b and the first flow guiding hole 161a as well as the second flow guiding hole 162a, so as to avoid water leakage when the water softener valve 100 is working.

In order to ensure the sealability between the second end cap 20b and the valve body 10, optionally, the water softener valve 100 further includes a first sealing ring and a second sealing ring. The first flange 21c is provided with a first annular groove 211 for the first sealing ring to be sleeved with, the second flange 22b is provided with a second annular groove 221 for the second sealing ring to be sleeved with.

In one embodiment, referring to FIG. 30, the valve body 10 is provided with a second end surface 11a in the first direction, the water-inlet passage 160 and the wastewater passage 162 are respectively provided with a water-inlet port 151 and a wastewater port 153 in the second end surface. The cross-sectional dimension of the water-inlet port 151 is larger than that of the wastewater port 153, and the aperture of the first flow guiding hole 161a is larger than that of the second flow guiding hole 162a.

It should be understood that, the water-inlet port 151 and the wastewater port 153 are disposed on the same end of the valve body 10 in the first direction, allowing the arrangement of the external ports of the valve body 10 to be more neatly. The water-inlet port 151 and the water-inlet passage 160, as well as the wastewater port 153 and the wastewater passage 162 are both linearly connected in the first direction, making the waterway more smooth. In addition, considering that the flow of the water-inlet passage 160 is generally larger than that of the wastewater passage 162 in practice, the cross-sectional dimension of the water-inlet port 151 is designed to be larger than that of the wastewater port 153, and the aperture of the first flow guiding hole 161a is designed to be larger than that of the second flow guiding hole 162a, which better meets the actual demands, and makes the overall structural design of the water softener valve 100 more reasonable, beneficial to the full use of the external space of the valve body 10.

In some embodiments, the second end cap 20b is detachably fixed to the first end surface 16a, to facilitate cleaning the pipe inside the valve body 10. For example, the second end cap 20b and the first end surface 16a is integrally connected by means of a snap connection, a screw connection or other detachable mating manners. When the pipe inside the water softener valve 100 needs to be unblocked, the second end cap 20b is removed, and the inside of the valve body 10 can be cleaned and unblocked through the first flow guiding hole 161a and the second flow guiding hole 162a.

In some embodiments, the outer peripheral surface of the first end surface 16a adjacent to the first flow guiding hole 161a and the second flow guiding hole 162a is provided with a plurality of fixing holes, the second end cap 20b corresponding to the fixing holes is provided with through holes. The fixing holes and the through holes are connected by fastening members to lock the second end cap 20b and the valve body 10. Specifically, during assembly, the through hole on the second end cap 20b is aligned with the fixing hole in the first end surface 16a, the fastening member (such as a screw, a bolt, and so on) is sequentially passed through the through hole and the fixing hole, and then tightened, so that the second end cap 20b is locked to the valve body 10. By using the fastening member to lock and fix, the assembly between the second end cap 20b and the valve body 10 is more firm and reliable, so as to prevent the second end cap 20b from loosening or falling off during the working process of the water softener valve 100.

Referring to FIG. 30 and FIG. 37, to ensure assembly stability, optionally, there are three fixing holes, which are a first sub-fixing hole 163a, a second sub-fixing hole 164a and a third sub-fixing hole 165a. The first sub-fixing hole 163a is disposed between the first flow guiding hole 161a and the second flow guiding hole 162a, the second sub-fixing hole 164a is disposed on the outer peripheral edge of the first flow guiding hole 161a away from the first sub-fixing hole 163a, and the third sub-fixing hole 165a is disposed on the outer peripheral edge of the second flow guiding hole 162a away from the first sub-fixing hole 163a. The second end cap 20b, corresponding to the first sub-fixing hole 163a, the second sub-fixing hole 164a and the third sub-fixing hole 165a, is respectively provided with a first through hole 23b, a second through hole 24b and a third through hole 25a. The first sub-fixing hole 163a, the second sub-fixing hole 164a and the third sub-fixing hole 165a may be substantially triangularly distributed, so as to realize stable assembly between the second end cap 20b and the valve body 10 by a small number of fastening members.

In some embodiments, the outer peripheral surface of the second end cap 20b between the second through hole 24b and the third through hole 25a is provided with a second recess 26a, convenient for users to hold the second end cap 20b, thereby facilitating the assembly and disassembly of the second end cap 20b.

In one embodiment, referring to FIG. 35, the first flow guiding hole 161a is disposed adjacent to the second flow guiding hole 162a, and the axes of the first flow guiding hole 161a and the second flow guiding hole 162a are staggeredly arranged both in the first direction and the third direction, the first direction is perpendicular to the third direction.

In some embodiments, the first direction is a front-rear direction, the third direction is a up-down direction. The first flow guiding hole 161a is disposed adjacent to the second flow guiding hole 162a, the first guiding hole 161a and the second guiding hole 162a are arranged in a staggered manner both in the front-rear direction and the up-down direction, which allows to make full use of space of the first end face 16a in all directions, thereby balancing the overall structure of the valve body 10, not too large in the size of a certain direction.

In some embodiments, referring to FIGS. 30, 31 and 34, the water-outlet passage 161 and the salt suction passage both extend along the first direction, and are respectively provided with a water-outlet port 152 and a salt suction port 13b in the second end surface 11a of the valve body 10. The valve body 10 further includes a mounting head 18b disposed on the side of the valve cavity 11 in the third direction. The mounting head 18b includes a first annular cylinder 181 and a second annular cylinder 182 extending along the third direction. The first annular cylinder 181 is disposed outside the second annular cylinder 182, the first annular cylinder 181 and the second annular cylinder 182 form the softening-inlet passage 163 therebetween, and a softening-outlet passage 164 is formed of the second annular barrel 182 forms a soft exit passage 164. and the cavity of the second annular cylinder 182 forms the softening-outlet passage 164. The end of the softening-inlet passage 163 away from the second end surface 11a communicates with the valve body 11, the end of the softening-outlet passage 164 close to the second end surface 11a communicates with the valve body 11. The second flow guiding hole 162a is disposed on the side of the first flow guiding hole 161a away from the second end surface 11a.

It should be understood that, the water-inlet passage 160, the water-outlet passage 161, the wastewater passage 162 and the salt suction passage all extend along the first direction, the softening-inlet passage 163 and the softening-outlet passage 164 both extend along the third direction, and the water-inlet port 151, the water-outlet port 152, the wastewater port 153 and the salt suction port 13b are disposed in the second end surface 11a of the valve body 10, the first flow guiding hole 161a and the second flow guiding hole 162a are disposed in the first end surface 16a of the valve body 10, which makes the arrangement of internal pipeline structure and external ports of the water softener valve 100 more regular, and the structure more compact. The second flow guiding hole 162a is disposed on the side of the first flow guiding hole 161a away from the second end surface 11a, so that, during the salt suction backwashing process, the waste water, after being drained from the softening-inlet passage 163 to the valve cavity 11, can be quickly discharged from the second flow guiding hole 162a into the wastewater passage 162 for discharge, which makes the arrangement of the pipelines inside the valve body 10 more reasonable, thereby improving the overall working efficiency of the water softener valve 100.

In one embodiment of the present disclosure, as shown in FIG. 29 and FIG. 38, the water softener valve 100 includes a valve body 10, the valve body 10 includes a valve cavity 11 as well as a water-inlet passage 160, a water-outlet passage 161, a softening-inlet passage 163, a softening-outlet passage 164, a wastewater passage 162 and a salt suction passage. The valve cavity 11, the wastewater passage 162 and the salt suction passage all extend along the first direction, the valve body 10 is provided with a second end surface 11a in the first direction, the wastewater passage 162 and the salt suction passage are respectively provided with a wastewater port 153 and a salt suction port 13b in the second end surface 11a. The softening-outlet passage 164 extends perpendicular to the first direction. The second end surface 11a is provided with a third flow guiding hole 14a, the third flow guiding hole 14a extends along the first direction and communicates with the softening-outlet passage 164. The water softener valve 100 further includes a wastewater drain nozzle 20a disposed at the wastewater port 153, a water injection salt suction nozzle 30a disposed at the salt suction port 13b, and a third end cap 40 detachably covering the third flow guiding hole 14a. The third end cap 40 is further configured, together with the valve body 10, to limit the wastewater drain nozzle 20a and the water injection salt suction nozzle 30a.

The valve cavity 11, the wastewater passage 162 and the salt suction passage all extend along the first direction, the wastewater port 153 and the salt suction port 13b may be disposed at either end of the valve body 10 in the first direction. To facilitate mounting the water softener valve 100 in an ion exchange tank 200 of the water softener, in some embodiments, the first direction is consistent with the front-rear direction, the wastewater port 153 and the salt suction port 13b are disposed at the front end of the valve body 10, namely the second end surface 11a is the front end surface of the valve body 10. The softening-outlet passage 164 extends in a direction perpendicular to the first direction. To match the position of the ion exchange tank 200, the softening-outlet passage 164 generally extends along the vertical direction. The softened water flowing out from the softening-outlet passage 164 may be guided to the inside of the valve cavity 11 along the first direction via the third flow guiding hole 14a.

The third end cap 40 detachably covers the third flow guiding hole 14a to seal water of the third flow guiding hole 14a. The third end cap 40 and the valve body 10 may be detachably fixed by a snap connection, a screw connection and so on. And the third end cap 40 is further configured to limit the wastewater drain nozzle 20a and the water injection salt suction nozzle 30a. For example, the edge of the third end cap 40 is fixed to the wastewater drain nozzle 20a and the water injection salt suction nozzle 30a by crimping, or the third end cap 40 is provided with a fixing structure for fixing the wastewater drain nozzle 20a and the water injection salt suction nozzle 30a, both playing a fixed role by limiting positions. In this way, a plurality of functions is realized by the third end cap 40, which effectively simplifies the types of parts in the water softener valve 100, reducing the manufacturing cost.

In the water softener valve 100 of the present disclosure, the layout of the pipelines inside valve body 10 and the external connectors is optimized, the wastewater passage 162 and the salt suction passage both extend along the first direction, the softening-outlet passage 164 extends perpendicular to the first direction, the wastewater port 153, the salt suction port 13b and the third flow guiding hole 14a are all disposed in the same second end surface 11a of the valve body 10, which makes the arrangement of internal pipeline structure and external ports of the water softener valve 100 more regular, and the structure more compact. The third end cap 40 is configured to cover the third flow guiding hole 14a to seal the water, and limit the wastewater drain nozzle 20a disposed at the wastewater port 153 as well as the water injection salt suction nozzle 30a disposed at the salt suction port 13b. In this way, the third end cap 40 realizes functions of sealing water at one position and fixing at two positions, conducive to simplify the component types, and the simplification of the overall structure of the water softener valve 100. Thereby, the water softener valve 100 has a regular and compact structure, convenient for reducing the overall size of the water softener valve 100, and when applied to a water softener, the whole size can be effectively reduced.

In some embodiments, referring to FIG. 41, the side of the third end cap 40 facing the second end surface 11a is provided with a third flange 41a sealingly cooperated with third flow guiding hole 14a. During assembly, the third flange 41a is inserted in the third flow guiding hole 14a, to allow the third end cap 40 to be tightly cooperated with the second end surface 11a of the valve body 10, which simplifies the operation process, and ensures a better sealability between the third end cap 40 and the third flow guiding hole 14a.

To ensure the sealability between the third end cap 40 and the third flow guiding hole 14a, optionally, the outer peripheral surface of the third flange 41a is provided with an annular groove 411, and the water softener valve 100 further includes a first sealing ring 50 sleeved in the annular groove 411 and sealingly cooperated with the inner wall of the third flow guiding hole 14a.

In some embodiments, referring to FIG. 38, the third end cap 40, corresponding to the wastewater port 153, is provided with a first fixing hole 42a for the wastewater drain nozzle 20a to be passed through; the third end cap 40, corresponding to the salt suction port 13b, is provided with a second fixing hole 43 for the water injection salt suction nozzle 30a to be passed through. The first fixing hole 42a and the second fixing hole 43 are provided, the wastewater drain nozzle 20a is disposed through the first fixing hole 42a and fixed by the third end cap 40 limiting the position thereof; the water injection salt suction nozzle 30a is disposed through the second fixing hole 43 and fixed by the third end cap 40 limiting the position thereof. Therefore, the structure of the entire third end cap 40 is simple, and it also plays a good role in water sealing and fixation.

In some embodiments, the outer peripheral surface of the wastewater drain nozzle 20a is stepped taper set, and provided with a first stepped surface 21b facing the third end cap 40. The inner peripheral wall of the first mounting hole 111a is provided with a first limiting surface to be in an abutting cooperation with the first stepped surface 21b. During assembly, the wastewater drain nozzle 20a is connected to the wastewater port 153, the first fixing hole 42a is sleeved on the outer peripheral surface of the wastewater drain nozzle 20a, the first limiting surface abuts against the first stepped surface 21b, so as to limit the movement of the wastewater drain nozzle 20a in the first direction, ensuring the mounting stability of the wastewater drain nozzle 20a.

Similarly, to ensure of the mounting stability of the water injection salt suction nozzle 30a, optionally, the outer peripheral surface of the water injection salt suction nozzle 30a is stepped taper set, and provided with a second stepped surface 31 facing the third end cap 40, the inner peripheral wall of the second mounting hole 112a is provided with a second limiting surface to be in an abutting cooperation with the second stepped surface 31. During assembly, the water injection salt suction nozzle 30a is connected to the salt suction port 13b, the second fixing hole 43 is sleeved on the outer peripheral surface of the water injection salt suction nozzle 30a, the second limiting surface abuts against the second stepped surface 31, so as to limit the movement of the water injection salt suction nozzle 30a in the first direction, ensuring the mounting stability of the water injection salt suction nozzle 30a.

In some embodiments, the water softener valve 100 further includes a second sealing ring 60 and a third sealing ring 70. The second sealing ring 60 is sleeved on the outer peripheral surface of the wastewater drain nozzle 20a, and sealingly cooperated with the inner wall of the wastewater port 153. The third sealing ring 70 is sleeved on the outer peripheral surface of the salt suction port 13b, and sealingly mated with the inner wall of the water injection salt suction nozzle 30a. The wastewater drain nozzle 20a and the wastewater port 153 are sealingly connected by the second sealing ring 60, the water injection salt suction nozzle 30a and the salt suction port 13b are sealingly connected by the third sealing ring 70, which increases the mounting stability of the wastewater drain nozzle 20a and the water injection salt suction nozzle 30a, so as to ensure the normal operation of the water softener valve 100.

In some embodiments, referring to FIGS. 29, 38 and 40, the water-inlet passage 160 and the water-outlet passage 161 both extend along the first direction, the water-inlet passage 160 and the water-outlet passage 161 are respectively provided with a water-inlet port 151 and a water-outlet port 152 in the second end surface 11a. The water-inlet port 151 and the water-outlet port 152 are arranged side by side along the second direction, the wastewater port 153, the third flow guiding hole 14a and the salt suction port 13b are arranged side by side along the second direction, and the wastewater port 153, the third flow guiding hole 14a and the salt suction port 13b are located on the same side of the water-inlet port 151 and the water-outlet port 152 in the third direction. The first direction, the second direction, and the third direction are perpendicular to each other.

Thereby, the layout of the water-inlet passage 160 and the water-outlet passage 161 is optimized, so that the water-inlet passage 160, the water-outlet passage 161, the wastewater passage 162, and the salt suction passage all extend along the first direction, and the water-inlet port 151, the water-outlet port 152, the wastewater port 153 and the salt suction port 13b are all located in the same end surface of the valve body 10, so that the internal pipe structure and the external ports of the valve body 10 are more regular and compact. In addition, the water-inlet port 151 and the water-outlet port 152 are arranged side by side along the second direction, the wastewater port 153, the third flow guiding hole 14a and the salt suction port 13b are arranged side by side along the second direction, and the wastewater port 153, the third flow guiding hole 14a and the salt suction port 13b are located on the same side of the water-inlet port 151 and the water-outlet port 152 in the third direction, which takes full use of the space of each side of the second end surface 11a of the valve body 10, so that the overall structure of the valve body 10 is relatively uniform, and the size of a certain orientation is not excessive.

In some embodiments, the second direction is a left-right direction, the third direction is a vertical direction. In one embodiment, the wastewater port 153, the third flow guiding hole 14a and the salt suction port 13b are disposed at the lower side of the water-inlet port 151 and the water-outlet port 152 in the vertical direction.

In some embodiments, referring to FIG. 38 and FIG. 40, the third flow guiding hole 14a is located between the wastewater port 153 and the salt suction port 13b, the second end surface 11a is provided with a first mounting hole 111a, a second mounting hole 112a and a third mounting hole 113a. The first mounting hole 111a is located between the water-inlet port 151 and the water-outlet port 152, the second mounting hole 112a is located between the wastewater port 153 and the third flow guiding hole 14a, the third mounting hole 113a is located between the third flow guiding hole 14a and the salt suction port 13b. The third end cap 40, corresponding to the first mounting hole 111a, the second mounting hole 112a and the third mounting hole 113a, is respectively provided with a first assembly hole 44, the second assembly hole 45 and the third assembly hole 46.

By the mating of the first mounting hole 111a with the first assembly hole 44, the second mounting hole 112a with the second assembly hole 45, and the third mounting hole 113a with the third assembly hole 46, the covering body and the valve body 10 are fixedly connected. Specifically, during assembly, each mounting hole is docked with the corresponding assembly hole, then respectively locked by the second fastening member 80. The second fastening member 80 may be a screw or a pin or the like. Since the water softener valve 100 needs to bear a certain water pressure during operation, the assembly stability and sealing reliability of the third end cover 40 can be ensured by the cooperation of the plurality of mounting holes and assembly holes, so as to prevent the third end cap 40 from being loose or detached when the water softener valve 100 in operation.

The present disclosure also provides a water softener, referring to FIGS. 12-16, the water softener includes an ion exchange tank 200, a salt box 300, and a water softener valve 100. The specific structure of the water softener valve 100 refers to the above embodiments. Since the water softener adopts all the technical solutions of the above embodiments, at least, the water processing apparatus obtains all the effects brought by the technical solutions of the above embodiments, which are to be detailed herein.

Specifically, the ion exchange tank 200 includes a tank body 201 and a central tube 202 disposed in the tank body 201. An ion exchange chamber 203 is formed between the central tube 202 and the inner wall of the tank body 201. The softening-inlet passage 163 communicates with the ion exchange chamber 203, the softening-outlet passage 164 communicates with the central tube 202, and the salt suction passage communicates with the salt box 300. The ion exchange chamber 203 receives ion exchange filter material. In one embodiment, the ion exchange filter material is soft water resin, so that the calcium ions and magnesium ions in the water to be processed can be conveniently replaced with sodium ions, and during the regeneration process, the calcium ions and magnesium ions are discharge again.

What is claimed is:

1. A water softener valve, comprising:
a valve body, a spacer group, and a piston assembly, the piston assembly comprising a piston body and a piston rod, wherein,
the piston assembly defines a water passage through two ends of the piston assembly, the outer peripheral surface of the piston body is alternately defined with a plurality of sealing surfaces and communicating grooves along a press-in direction; the spacer group and the inner peripheral surface of an valve cavity of the valve body forms a plurality of gate grooves arranged along the press-in direction;
the valve cavity is defined with a proximal cavity and a distal cavity respectively adjacent to the proximal end and the distal end of the spacer group along the press-in direction; the inner wall of the valve cavity corresponding to the plurality of gate grooves is defined with a water-inlet inner hole, a water-outlet inner hole, a forward washing water-inlet port, a forward washing jet flow hole, a softening-inlet port, and a wastewater inner hole, corresponding to the distal cavity is defined with a softening-outlet port; the proximal cavity and the adjacent gate groove, two adjacent gate grooves, and the gate groove and the adjacent distal cavity, are respectively blocked by a corresponding sealing surface or communicated by a corresponding communication groove.

2. A water softener valve of claim 1, wherein, the inner wall of the valve cavity corresponding to the plurality of gate grooves is further defined with a backwashing water-inlet port, and corresponding to the distal cavity is defined with a backwashing jet flow hole.

3. A water softener valve of claim 2, wherein, the plurality of gate grooves comprises a first gate groove, a fourth gate groove, as well as a second gate groove and a third gate groove defined between the first gate groove and the fourth gate groove;
the proximal cavity is adjacent to the first gate groove, the distal cavity is adjacent to the fourth gate groove;
the inner wall of the valve cavity corresponding to the first gate groove is defined with the wastewater inner hole;
the inner wall of the valve cavity corresponding to the second gate groove is defined with the forward washing jet hole and the softening inlet port;
the inner wall of the valve cavity corresponding to the third gate groove is defined with the forward washing water-inlet port and the water-inlet inner hole; and
the inner wall of the valve cavity corresponding to the fourth gate groove is defined with the backwashing water-inlet port and the water-outlet inner hole.

4. A water softener valve of claim 3, wherein,
the plurality of sealing surfaces comprise a first sealing surface, a second sealing surface, and a third sealing surface, the plurality of communicating grooves comprise a first communicating groove and a second communicating groove;
the first sealing surface, the first communicating groove, the second sealing surface, the second communicating groove, and the third sealing surface are alternately arranged along the press-in direction in sequence; and the first gate groove, the second gate groove, the third gate groove, and the fourth gate groove are sequentially arranged along the press-in direction.

5. A water softener valve of claim 1, wherein, the valve body comprises a main body and a first end cap, the main body defines an inner cavity with one end open; the first end cap covers the open of the valve body and cooperates with the valve body to form the valve cavity.

6. A water softener valve of claim 5, wherein,
the piston rod extends out of the valve body through the first end cap, the proximal cavity is adjacent to the first end cap, the valve cavity has a bottom surface opposite to the first end cap;
the water softener valve further comprises an annular irregular grid, the irregular grid defines a recess toward the bottom surface, the distal cavity is defined between the recess and the bottom surface; the spacer group is pressed between the first end cap and the irregular grid.

7. A water softener valve of claim 1, wherein, the water softener valve comprises a driving mechanism, the driving mechanism comprises a mounting seat and a cam, the end of the piston rod extending out of the valve body is transmission cooperated with the cam;
the mounting seat is defined with a sliding connection structure, the end of the piston rod extending out of the valve body is defined with a sliding cooperation portion, the sliding cooperation portion is slidably cooperated with the sliding connection structure along a longitudinal direction, and the sliding cooperation portion is position-limiting cooperated with the sliding connection structure along a lateral direction;
the sliding connection structure comprises two slideways opposite to each other along the lateral direction, and the sliding cooperation portion extends into the two slideways and located between the two slideways, and is slidably cooperated with the two slideways along the longitudinal direction respectively;
the longitudinal direction coincides with the length direction of the piston rod, the lateral direction is perpendicular to the longitudinal direction and the axial direction of the cam.

8. A water softener valve of claim 7, wherein, the piston rod comprises a rod portion and a transmission cooperation portion defined on one end of the rod portion, the transmission cooperation portion is defined on the outer side of the valve body, the sliding cooperation portion comprises a plurality of sliding shafts defined on the side of the transmission cooperation portion away from the cam, the plurality of sliding shafts are arranged in two rows to respectively slidably cooperated with one of the two slideways along the longitudinal direction.

9. A water softener valve of claim 8, wherein, the transmission cooperation portion protrudes from the peripheral surface of the rod portion along the lateral direction, the transmission cooperation portion is defined with a sliding groove extending along the lateral direction, the cam is defined with an eccentric shaft adapted to the sliding groove, and the plurality of sliding shafts are defined at the periphery of the sliding groove.

10. A water softener valve of claim 1, wherein, the water softener valve comprises:
a control box, comprising a housing assembly and a transmission mechanism, the housing assembly being configured to connect to the valve body of the water softener valve, the transmission mechanism comprising a driving member movably mounted in the housing assembly, the driving member being configured to connect to the piston rod, to drive the piston rod to move, the driving member being defined with an inductive structure; and
an electronic control board, mounted in the housing assembly, the electronic control board being defined with a plurality of inductors, the plurality of inductors being configured to sense the inductive structure, and output corresponding electronic signal when the inductive structure moves into an inductive area of the inductors.

11. A water softener valve of claim 10, wherein, the driving member is rotatably connected to the housing assembly, the plurality of inductors are distributed around the rotation axis of the driving member.

12. A water softener valve of claim 11, wherein, the transmission mechanism further comprises a transmission gear, the transmission gear is configured to connect to a motor of the water softener valve, the driving member comprises a cam, the outer peripheral surface of the cam is defined with gear rings, the gear rings engage with the transmission gear, and the cam is configured to connect to the piston rod, to drive the piston rod to move;
the electronic control board is defined on the side of the gear rings away from the cam, the inductive structure is defined on the cam, and the inductors are defined on the side of the electronic control board facing the gear rings.

13. A water softener valve of claim 1, wherein, the valve body comprises a water-inlet passage, a water-outlet passage, a softening-inlet passage, a softening-outlet passage, a wastewater passage, and a salt suction passage all communicated with the valve cavity, the valve cavity, the water-inlet passage, and the wastewater passage extend along a first direction, the valve body has a first end surface at a second direction, the water-inlet passage and the wastewater passage are both defined adjacent to the first end surface; the first end surface defines a first flow guiding hole communicating with the water-inlet passage, and a second flow guiding hole communicating with the wastewater passage; the first direction is perpendicular to the second direction; the water softener valve further comprises a second end cap configured to cover the first flow guiding hole and the second flow guiding hole.

14. A water softener valve of claim 13, wherein, the surface of the second end cap cooperated with the first end surface is defined with a first flange and a second flange respectively corresponding to the first flow guiding hole and the second flow guiding hole; the first flange is sealingly cooperated with the inner wall of the first flow guiding hole, and the second flange is sealingly cooperated with the inner wall of the second flow guiding hole.

15. A water softener valve of claim 1, wherein, the valve body comprises a water-inlet passage, a water-outlet passage, a softening-inlet passage, a softening-outlet passage, a wastewater passage, and a salt suction passage all communicated with the valve cavity,
the valve cavity, the wastewater passage, and the salt suction passage extend along a first direction, the valve body is defined with a second end surface at the first direction, the wastewater passage and the salt suction passage respectively define a wastewater port and a salt suction port in the second end surface;
the softening-outlet passage extends perpendicular to the first direction, the second end surface is defined with a third flow guiding hole, the third flow guiding hole extends along the first direction and communicates with the softening-outlet passage;
the water softener valve further comprises a wastewater drain nozzle defined at the wastewater port, a water injection salt suction nozzle defined at the salt suction port, and a third end cap detachably covered at the third flow guiding hole; the third end cap is further configured, together with the valve body, to limit and fix the wastewater drain nozzle and the water injection salt suction nozzle.

16. A water softener valve of claim 15, wherein, the side of the third end cap facing the second end surface is defined with a third flange which is sealingly cooperated with the third flow guiding hole.

17. A water softener valve of claim 15, wherein, the third end cap corresponding to the wastewater port is defined with a first fixing hole for the wastewater drain nozzle to pass through; the third end cap corresponding to the salt suction port is defined with a second fixing hole for the water injection salt suction nozzle to pass through.

18. A water softener valve of claim 17, wherein, the outer peripheral surface of the wastewater drain nozzle is stepped taper set, and defined with a first stepped surface facing the third end cap, the inner peripheral wall of the first fixing hole is defined with a first limiting surface which abuts against the first stepped surface; and/or,
the outer peripheral surface of the water injection salt suction nozzle is stepped taper set, and defined with a second stepped surface facing the third end cap, an inner peripheral wall of the second fixing hole is defined with a second limiting surface which abut against the second stepped surface.

19. A water softener valve of claim 15, wherein, the water-inlet passage and the water-outlet passage both extend along the first direction, the water-inlet passage and the water-outlet passage are respectively defined with a water-inlet port and a water-outlet port in the second end surface; the water-inlet port and the water-outlet port are arranged side by side along the second direction, the wastewater port, the third flow guiding hole, and the salt suction port are arranged side by side along the second direction, and the wastewater port, the third flow guiding hole, and the salt suction port are defined on the same side of the water-inlet port and the water-outlet port along a third direction; the first direction, the second direction, and the third directions are perpendicular to each other.

20. A water softener, wherein, the water softener comprises a water softener valve, the water softener valve comprises:
a valve body, a spacer group, and a piston assembly, the piston assembly comprising a piston body and a piston rod, wherein,
the piston assembly defines a water passage through two ends of the piston assembly, the outer peripheral surface of the piston body is alternately defined with a plurality of sealing surfaces and communicating grooves along a press-in direction; the spacer group and the inner peripheral surface of an valve cavity of the valve body forms a plurality of gate grooves arranged along the press-in direction;
the valve cavity is defined with a proximal cavity and a distal cavity respectively adjacent to the proximal end and the distal end of the spacer group along the press-in direction; the inner wall of the valve cavity corresponding to the plurality of gate grooves is defined with a water-inlet inner hole, a water-outlet inner hole, a forward washing water-inlet port, a forward washing jet flow hole, a softening-inlet port, and a wastewater inner hole, corresponding to the distal cavity is defined with a softening-outlet port; the proximal cavity and the adjacent gate groove, two adjacent gate grooves, and the gate groove and the adjacent distal cavity, are respectively blocked by a corresponding sealing surface or communicated by a corresponding communication groove.
